(19) United States
(12) Patent Application Publication
(10) Pub. No.: US 2004/0024738 A1
(43) Pub. Date: Feb. 5, 2004

(54) Multidimensional index generation apparatus, multidimensional index generation method, approximate information preparation apparatus, approximate information preparation method, and retrieval apparatus

(75) Inventor: Yasuo Yamane, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/436,999

(22) Filed: May 14, 2003

(30) Foreign Application Priority Data
May 17, 2002 (JP) 2002-142443

(51) Int. Cl. G06F 7/00

(52) U.S. Cl. 707/1

(57) ABSTRACT

To cluster a space efficiently even in a high dimension, and realize high speed in a high dimension, and to perform similarity retrieval that can store approximate information without any waste and in a short form, can reduce an overall storage space, and can reduce the number of times of access of processing such as retrieval. There is provided a multidimensional index generation apparatus for dividing a multidimensional space into a plurality of areas and generating a multidimensional index in association with the divided area, which arranges a regular simplex to be a reference in a certain position in the multidimensional space, arranges spheres at vertexes of the arranged regular simplex, and divides the multidimensional space by the spheres.

### BACKGROUND OF THE INVENTION

1. Field of the Invention

The present invention relates to a retrieval apparatus that is arranged to retrieve an item similar to or identical with a designated one, and a multidimensional index generation apparatus, a multidimensional index generation method, an approximate information preparation apparatus, and an approximate information preparation method that are applied to the retrieval apparatus. In particular, the present invention relates to those apparatuses and methods that are arranged to be able to perform the retrieval and similarity retrieval at a high speed.

2. Description of the Related Art

In the field of a computer, what is called similarity retrieval is often performed as retrieval. The similarity retrieval is processing for searching an item similar to or identical with a certain item. For example, it is processing for, when one wishes to search an image of a handbag, searching a photograph on which the handbag is printed by showing another photograph on which the handbag is printed.

The similarity retrieval is used in various media and is widespread. For example, concerning an image, an image that is expected to have the sky printed thereon is retrieved as an image similar to an image on which the sky is printed. In addition, concerning sound, retrieval is known which searches a tune similar to a strain of a tune that one sang to himself/herself as sound.

When a retrieval apparatus for performing similarity retrieval is constituted by using a computer, a plurality of characteristics (e.g., color and shape) of an object like an image (hereinafter referred to as object) are generally extracted as numerical values and are represented as points in a multidimensional space having a set of the numerical values as coordinates. If n characteristics are extracted, the characteristics are represented as points in an n-dimensional space. A dimension ranges from a few dimensions to as large as several hundred dimensions. A point corresponding to an object is correctly referred to as an object point. However, if it is not likely that misunderstanding occurs, it is simply referred to as a point.

A point in a multidimensional space is also considered to be a position vector from an origin. A vector is a concept of an arrow from a start point to an end point and is a concept having both a direction and a length. A start point of a vector does not have to be a specific point. However, a specific point such as an origin is considered to be a start point and a vector representing a position of the point is specifically referred to as a position vector. When one wishes to grasp a point specifically as a position vector, that is, when one wishes to grasp it as a volume having a direction and a length, a term of vector is used. In a case of an object point, a vector is referred to as an object vector or simply as a vector.

In an inquiry of similarity retrieval, an item is often designated to retrieve an item similar to the item itself. A point corresponding to this designated item is referred to as a designated point. An item to be designated may be an object that has become a retrieval object or may be other items. This is because it is likely that a point designated by a user may be different from a point of an object already stored.

There are roughly two kinds of inquiries of similarity retrieval, namely, ranking retrieval and range retrieval. The ranking retrieval is retrieval for retrieving objects of superior k items close to a designated point. The range retrieval is retrieval for retrieving all objects within a certain distance from a designated point.

In the course of processing of the similarity retrieval, a sphere with a designated point as a center is often used either in the ranking retrieval or the range retrieval. This sphere is referred to as vicinity (neighborhood). A radius of the sphere is referred to as a radius of the vicinity. In addition, information on coordinates of an object point is stored in a secondary memory as a record. This record is referred to as a point record. If data for m objects is stored, the data is stored as m point records.

A simplest method of the similarity retrieval is a sequential method of checking for all points in a multidimensional space whether the points are close to a designated point. However, this method takes an extremely long time because all point records are accessed. Thus, a large number of methods are proposed which prepare an index called a multidimensional index other than the point records and use this index to reduce accesses to point records.

In the multidimensional index, a space is generally divided into a plurality of areas by a solid such as a cuboid or a sphere. An area occupied by this solid is referred to as a cluster. Then, points included in the cluster are managed collectively. In the SS-tree method ‘see [White96] D. A. White et al.: “Similarity Indexing with the SS-tree”, Proc. 12^{th} ICDE, pp.516-523 (1996)’, a sphere is a cluster and a space is divided into a plurality of spheres. In the R*tree method ‘see [Beckmann90] N. Beckmann: “The R*-tree: An Efficient and Robust Access Method for Points and Rectangles”, Proc. SIGMOD 1990, pp.322-331 (1990)’, a cluster is a cuboid and a space is divided into a plurality of cuboids. At the time of retrieval, only clusters close to a designated point are retrieved, whereby the number of times of access to point records is reduced. In many cases, information in a cluster is accessed collectively during processing. Therefore, the information is desirably stored on a secondary memory collectively. Bringing information into this state is referred to as clustering.

Information on a cluster or information on points included in the cluster is managed within a multidimensional index as a retrieval record (index record). Although the index record may be referred to as an index record, it is referred to as a index record for simplicity. Any multidimensional index has this index record inside it.

A sphere means a figure including points in its inside. The term is used to mean this in this specification. A surface of a sphere is referred to as a spherical surface. A sphere expanded to four-dimensional or more is referred to as a super sphere. A distance between two points in a two-dimensional space is represented as follows when coordinates of the two points are assumed to be (x(1), x(2)) and (y(1), y(2)), respectively:

sqrt((x(1)−(y1))\hat{ }2+(x(2)−y(2))\hat{ }2).

Similarly, in an n-dimensional space, when coordinates of the two points are assumed to be (x(1), x(2), . . . , x(n)) and (y(1), y(2), . . . , y(n)), respectively, the distance is represented as follows:

sqrt((x(1)−(y1))\hat{ }2+(x(2)−y(2))\hat{ }2+ . . . +(x(n)−((n))e\hat{ }2)

where, x\hat{ }y means y-th power of x and sqrt(x) means a root of x.

The super sphere means a set of points whose distance from a certain point (center) is within a distance called a radius in an n-dimensional space. The super sphere is natural expansion of a two-dimensional circle or a three-dimensional sphere. However, in this specification, it is simply referred to as a sphere for simplicity. Points inside a sphere with a radius r having an origin as a center in the n-dimensional space satisfies the following inequality:

(x(1)\hat{ }2+x(2)\hat{ }2+ . . . +x(n)\hat{ }2)<=r2.

Points on a spherical surface satisfy the following equation:

(x(1)\hat{ }2+x(2)\hat{ }2+ . . . +x(n)\hat{ }2)=r\hat{ }2.

A sphere or a cube in the n-dimensional space is a figure obtained by expanding a two-dimensional circle or square to the n-dimension. Similarly, a figure obtained by expanding a two-dimensional triangle to the n-dimension is referred to as a regular simplex. A triangle has three vertexes and two vertexes are connected by a side. A three-dimensional simplex is a tetrahedron, which has four vertexes. Any two vertexes are connected by a side. Similarly, an n-dimensional simplex has n+1 vertexes and is a figure in which any two vertexes are connected by a side. A simplex is a simplest figure among figures having a volume in an angulated space. A regular simplex refers to a simplex in which all distances between any two vertexes, that is, lengths of sides are equal. Actually, all lengths of sides are equal in a regular triangle and a regular tetrahedron.

Incidentally, various methods have been proposed conventionally concerning the multidimensional index ‘see [Gaede98] V. Gaede et al.: “Multidimensional Access Methods”, ACM Computing Surveys, Vol. 30, No. 2, (June 1998)’. These methods are roughly classified as follows:

a) Classification by a Division Method

a-1) Data Division

If data included in a cluster is full, the data is divided as equally as possible. This division has a preferable nature in that a hierarchical structure generally becomes a balance tree and, if a leaf node is accessed from a root node, the number of times of accesses becomes constant.

a-2) Space Division

A space is equally divided. This division has a disadvantage in that the number of point data included in a cluster varies. However, the space can always be divided regularly.

b) Classification According to a Structure

b-1) Hierarchical Type

An index has a hierarchical structure. By dividing a multidimensional space into partial areas hierarchically, a retrieval range is limited to realize speed-up.

b-2) Flat Type

An index does not have a hierarchical structure but has a flat structure like a one-dimensional array. Other than these categories, several methods based on approximation have been proposed recently.

(Data Division Method)

1) R-Tree

If an index based on a one-dimensional order is attached in a commercial database system, a B-tree is generally used. An R-tree is a tree obtained by naturally expanding the B-tree multidimensionally. Data ordered one-dimensionally is divided into a plurality of sections in the B-tree. On the other hand, in the R-tree, a set of object points is divided into smallest cuboids including a point called MBR (Minimum Bounding Rectangle) and the cuboids are formed hierarchically, thereby creating a hierarchical structure as in the B-tree. This MBR corresponds to sections in the B-tree. The hierarchical structure of the R-tree has an excellent nature similar to that of the B-tree in that it is a tree with a balanced height (all leaves have the same height) and retrieval to any point can be performed in the same number of times of input/output. In addition, it is excellent in a dynamic characteristic. That is, even if update processing is added, the processing does not take a long time and, in addition, since the tree is balanced, its performance is not deteriorated significantly by the update processing.

2) SS-Tree

This is an improvement of the R-tree. Whereas a cuboid is used in the R-tree, a sphere is used in the SS-tree. The SS-tree has a better performance than the R-tree in the similarity retrieval.

3) SR-Tree (Sphere Rectangle Tree)

This is an improvement of the SS-tree. Whereas a sphere is used in the SS-tree, a common part of a sphere and a cuboid is used in the SR-tree. The SR-tree has a better performance than the SS-tree.

(Space Division Method)

4) Quad-Tree

This method will be described in the two-dimension first. It is assumed that a set of object points is included in a square whose center coincides with an origin. This square is equally divided into four areas by the x-axis and y-axis. Then, if a plurality of points are included in each area, the area is further divided into four areas. This operation is repeated recursively. In the case of the n-dimension, an n-dimensional cube is divided into 2\hat{ }n areas recursively. According to these operations, the area is constituted as a hierarchical index called a quad-tree. Note that this tree is not a balance tree. That is, a distance from a root to a leaf is not constant. This method is different from the above-mentioned three methods of dividing data in this point. In this method, a partial area is divided into independent areas without overlapping. This method is more excellent than the above-mentioned three methods in this point. In the above-mentioned three methods, clusters are allowed to mix with each other. This method is also used for coding of images and the like.

(Method Based on Approximation)

5) VA-File (Vector Approximation File)

Whereas the above-mentioned 1) to 4) have a hierarchical index structure, an index is an array and has a flat structure in this method. Elements of the array have approximate information that is compressed coordinates information on a point. The approximate information is based on these rectangular coordinates. All the elements of the array are sequentially checked, and filtering is performed based on the approximate information. In a high dimension, this method has a better performance than the SR-tree.

6) A-Tree (Approximation Tree)

This is a method collaboratively developed by NTT and Nara Advanced Technology University. Approximate information takes a hierarchical structure rather than a flat structure as in the VA-file. It has a better performance than the SR-tree or the VA-file. It exhibits a performance in which the number of times of input/output is ¼ or less of that of the SR-tree or the VA-file with 64-dimensional actual data. It has the same degree of performance as the VA-file with respect to uniform data. Compared with the SR-tree, the number of accesses to an index page is as small as ⅓ of that of SR-tree and, in particular, the number of accesses to a data page is extremely small in the order of 1/30.

Incidentally, in the multidimensional index, it is important to reduce access to a point record or an index record. As a method for this, a method of reducing the number of times of access is proposed which extracts shorter information from the point record or the index record (this information is referred to as approximate information), and uses the approximate information to determine whether it is necessary to access the point record or the index record. Reducing the number of times of access using this method is referred to as filtering. Finding an approximate position is referred to as approximation. If this is compared to a map, it corresponds to finding information indicating an approximate position such as a country, a prefecture or a city as opposed to an address as accurate as a number of street.

The approximate information is information for approximating points and cluster represented by a point record or an index record. Filtering is a method of filtering out points or clusters that are apparently distant from a designated point using the approximate information. Therefore, some points or clusters are not sorted out by this filtering. It is necessary to access the point record or the index record with respect to these points or clusters. That is, a solution that should be found by the filtering is not perfectly found. The filtering is processing for narrowing down candidates of a solution.

It is assumed that the number m of entire object points is narrowed down to m′ candidates by filtering. At this point, a ratio m′/m is referred to as a filtering ratio. A method with less data volume of approximate information and a high filtering ratio is desired.

In general, an n-dimensional space is considered in this specification. In this case, an n+1-dimensional solid is often considered simultaneously with the n-dimensional solid. However, since the n-dimensional space is usually hard to consider, in many cases, the n-dimensional solid is considered in a three-dimension and the n+1-dimensional solid is considered in a two-dimension to apply them to a multidimension. An n-dimensional sphere is considered as a three-dimensional sphere and an n+1-dimensional sphere is considered as a circle. In terms of facilitating such an idea, the n+1-dimensional sphere is referred to as a circle. In addition, its surface is referred to as a circumference. This is also meant to save adding a note of n+1 dimension every time the n+1-dimensional sphere appears.

In addition, a two-dimensional square or a three-dimensional cube expanded to an n-dimension is generally referred to as a super cube. However, here, it is simply referred to as a cube as in the above description. A surface of a cube is referred to as a cube surface. This is the same for a cuboid.

In addition, an n+1-dimensional cube is simply referred to as a square as opposed to the n-dimensional cube in the same manner as the relationship between a sphere and a circle. Its surface is referred to as a square circumference in the same manner as a circumference of a circle. Moreover, an n+1-dimensional space is often referred to as a super plane as opposed to an n-dimensional space. Here, it is simply referred to as a plane in the same manner as a sphere and a cube.

Incidentally, as a method of filtering, a method described below is basically used conventionally.

Here, it is assumed that an approximate object point according to rectangular coordinates exists in a cuboid. When this cuboid is divided at an equal interval for each coordinate axis, the cuboid can be divided into a plurality of partial cuboids. This partial cuboid is referred to as a cell. Then, information on which cell an object point belongs to is assumed to be approximate information. Compared with representing an object point with accurate coordinates, since it is not seen where in the cell the object point exists, the information is approximate. However, it can be represented with far less volume for that as information.

This will be described in more detail as follows. Coordinates of a point x in an n-dimensional space are assumed to be (x(1), x(2), . . . , x(n)). A range of x(i) is assumed to be a section [min(i), max(i)]. At this point, with m as an integer value, the section [min(i), max(i)] is divided into 2\hat{ }m sections of the same length. Depending on which section x(i) belongs to, a number b(i) of 0 to 2\hat{ }m−1 is assigned to x(i). Consequently, a set of integer values of b=(b(1), b(2), . . . , b(n)) is associated with the point x. This b represents a cell. x(i) is represented by a floating point number of a single precision (four bytes) or a floating point number of a double precision (eight bytes). On the other hand, since b(i) can be represented by m bits, it generally has far less information volume. According to information in this b, it is determined whether vicinity and this cuboid intersect with each other. If they do not intersect, the point is not included in the vicinity. Thus, it is not necessary to access the point record, and the number of times of access can be reduced.

A basic idea of this method is used in methods that are currently said to be fastest in a high-dimensional space such as VA-file[UVeber98] ‘see R. Weber et al.: “A Quantitative Analysis and Performance Study for Similarity-Search Methods in High-Dimensional Spaces”, Proc. 24th VLDB, pp.194-205 (1998)’ and A-tree[Sakurai00] ‘see Y. Sakurai et al.: “The A-tree: An Index Structure for High-Dimensional Spaces Using Relative Approximation”, Proc. 26th VLDB, pp.516-526 (2000)’.

(Multidimensional Index)

As the Internet and input apparatuses (scanner, digital camera) widespread, both the number and a volume of multimedia data are sharply increasing. As the number of multimedia data increases, a technique for retrieving the data is naturally required. In particular, in the case of multimedia, there are high expectations for similarity retrieval based on its contents. In addition, since the number of retrieval objects increases, a high-speed retrieval is required. In research and development of a multidimensional index, importance is often attached to this speed-up. A performance of the similarity retrieval is significantly affected by the number of times of input/output, and it is a key point how to reduce this number of times of input/output.

If the number of times of input/output is reduced, two points concerning a space efficiency and adaptability in a high dimension are important. As to the space efficiency, it is important to make a cluster and approximate information on the multidimensional index as compact as possible and reduce the number of times of input/output. As to the adaptability in a high dimension, accuracy of the similarity retrieval can be generally attained by increasing the number of characteristic volumes, that is, making a dimension of the multidimensional space higher. However, when a dimension is increased to as high as several tens dimensions to several hundred dimensions, as introduced in [Katayamaol] ‘see Katayama Norio et al.: “Index Technique for Similarity Retrieval”, Joho shori (Information Processing) Vol. 42, No. 10, pp. 958-964, (October 2001)’, a phenomenon called a curse of dimensionality occurs, and a performance of similarity retrieval generally falls. According to the curse of dimensionality, it is known that problems such as the similarity retrieval and multivariate analysis become difficult in a high dimension. These problems are collectively referred to as the curse of dimensionality. As a concrete example, when points are uniformly distributed in a multidimensional space, a phenomenon that, in view of a certain point, other points gather near a spherical surface with the point as a center. That is, there is little difference of distances.

In the similarity retrieval, even with the SR-tree that is said to be a high speed method, if it is attempted to divide data, clusters overlap with each other largely even if data is divided and an effect of clustering is diluted. It is a significant subject how to cope with the problem of the curse of dimensionality that occurs in this high dimension and attain speed-up.

(Filtering (Preparation of Approximate Information))

In the conventional technique, the inside of a cuboid is approximated by rectangular coordinates. On the other hand, there are provided a large number of multidimensional indexes using a sphere (see [Katayama97] ‘N. Katayama el al.: “The SR-tree: An Index Structure for High-Dimensional Nearest Neighbor Queries”, Proc. SIGMOD 1997, pp.369-380 (1997)’, [White96]). If it is attempted to approximate points in a sphere by a method according to a cuboid, the inside of a cube circumscribing the sphere is represented by rectangular coordinates as shown in FIG. 37. For simplicity, the case of a two-dimension will be described first. If it is attempted to approximate a point with the conventional method in the two-dimension, a result shown in FIG. 38 is obtained. Here, a point is approximated with total 256 square cells that are divided equally vertically and horizontally into sixteen pieces. A cell including a point P can be represented as (5,3). As the vertical and horizontal parts are divided into sixteen pieces, each can be represented as a bit, and total can be represented as 8 bit. However, in this case, areas such as (1,1) and (2,0) are outside the sphere. There are 40 or more such partial squares in total. That is, waste occurs in representation. This waste is less in the case of two-dimension. Next, a case of a high dimension will be described.

Now, it is assumed that a length of one side of a cube is 2. Therefore, a radius of a sphere inscribed in the cube is 1. At this case, it is known that volumes of an n-dimensional cube and sphere are given by the following expressions:

Volume of the cube=2\hat{ }n

Volume of the sphere=π\hat{ }(n/2)*r\hat{ }n/(n/2)! (n: even number)

4/3*π*r\hat{ }3 (n=3)

Here, x\hat{ }y means a y-th power of x and x! means a factorial of n (product of integers from 1 to x). A ratio of the volume of the cube with respect to the volume of the sphere for each dimension is as follows:

| Dimension | Volume of cube/Volume of sphere |
|---|---|
| 2 | 1.27 |
| 3 | 1.91 |
| 4 | 3.24 |
| 16 | 2.78*10\hat{ }5 |
| 64 | 5.99*10\hat{ }38 |
| 256 | 1.03*10\hat{ }229 |

That is, as the dimension becomes higher, since a volume of a part outside the sphere in the cuboid increases significantly, large waste occurs if the point in the sphere is represented by approximation according to the rectangular coordinate shown in the conventional technique. If this waste can be eliminated to make approximate information compact, speed-up of the similarity retrieval can be realized.

(Multidimensional Index and Filtering)

A database system, in particular, a relational database is becoming complicated according to expansion of a specification of SQL. As stated in [Chaudhuri00] ‘see S. Chaudhuri et al.: “Rethinking Database System Architecture: Towards a Self-tuning RISC-style Database System”, Proc. of Intl. Conf. of Very Large Database Systems, (2000)’, since functions of a database system are expanded and optimization is complicated, maintenance, management, performance estimate and the like are becoming difficult and maintenance costs and management costs are increasing. Thus, simplification is desired. In a page based method of controlling a page that is a unit of input/output by oneself, although clustering is easily controlled, a kernel part of the database system should be manipulated. The database system is becoming huge and complicated, and a lot of studies of an expansion database for facilitating such expansion of functions are performed. However, in an actual development side, if such expansion is performed, a large amount of costs are incurred including those for tests and maintenance as an actual situation. This seems to be a reason why a method of multidimensional index is not put into practice in spite of the fact that many methods of multidimensional index are proposed.

Since an application of a database system is created on an existing database system, it is unnecessary to manipulate a database as a matter of course. In addition, if an application is created based on a standard called SQL, the application can be run not only on one database system but also on database systems of many venders. In the method of manipulating a kernel, it is necessary to realize an application for each vender.

Similarly, if a method for a multidimensional index can be realized on a database system, it becomes easy to put the method into practice. If it is prepared based on the standard such as SQL, it also becomes possible to run it on many existing database systems. In this case, since no manipulation can be applied to a page, the application is realized by record manipulation, that is, the application is based on a record. Although in the record based application the application is easy to realize, since clustering cannot be controlled generally, it is required to reduce the number of times of access to a record.

### SUMMARY OF THE INVENTION

The present invention has been achieved in order to solve the above-mentioned problems, and it is an object of the present invention to provide a multidimensional index generation apparatus, a multidimensional index generation method, an approximate information preparation apparatus, an approximate information preparation method and a retrieval apparatus that can divide a sphere efficiently, can realize efficient use of a storage space, can attain speed-up of retrieval processing, and can establish the inside of a sphere with shorter approximate information to realize efficiency of a storage space and cost reduction, thereby being able to easily perform establishment of a system.

In order to solve the above-mentioned problem, the present invention provides a multidimensional index generation apparatus for dividing a multidimensional space into a plurality of areas and generating a multidimensional index in association with the divided areas in order to specify a predetermined point in the multidimensional space, which includes reference regular simplex arrangement means for arranging a regular simplex to be a reference in a certain position in the multidimensional space, and sphere arrangement means for arranging a sphere at a vertex of the regular simplex arranged by the reference regular simplex arrangement means and dividing the multidimensional space by the sphere. In an embodiment of the present invention, the reference regular simplex arrangement means and the sphere arrangement means are constituted by cooperation of a control device 11, a sphere generation device 12 and a point generation device 13.

In addition, the multidimensional index generation apparatus of the present invention further includes connection regular simplex arrangement means for arranging a plurality of regular simplexes by connecting the regular simplex to another regular simplex with the same size as the regular simplex once or more such that surfaces of both the regular simplexes join each other, and the sphere arrangement means is characterized by dividing the multidimensional space by arranging a sphere on a vertex of the regular simplex arranged by the reference regular simplex arrangement means as well as vertexes of the plurality of regular simplexes arranged by the connection regular simplex arrangement means.

Further, in the multidimensional index generation apparatus of the present invention, the reference regular simplex arrangement means or the connection regular simplex arrangement means is characterized by arranging a further regular simplex for a sphere arranged by the sphere arrangement means and dividing the sphere in a hierarchical manner by the sphere arrangement means arranging a further sphere at a vertex of the further regular simplex.

In the multidimensional index generation apparatus of the present invention, the multidimensional space is a sphere as a partial space, and the reference regular simplex arrangement means may also be characterized by arranging the regular simplex to be a reference such that the center of gravity of the regular simplex to be a reference coincides with a center of the sphere.

In addition, in the multidimensional index generation apparatus, the multidimensional space is a sphere as a partial space, and the reference regular simplex arrangement means may also be characterized by arranging the regular simplex to be a reference such that the center of gravity of the regular simplex to be a reference coincides with a center of a substantial sphere by a point included in the sphere of the multidimensional space.

Moreover, the multidimensional index generation apparatus may also be characterized by including judging means for judging the number of vectors included in a sphere and vector holding means for, based on a result of judgment by the judging means, if the number of vectors included in the sphere is small, holding the vectors as they are without turning the vectors into a sphere. Note that this vector holding means is also constituted by cooperation of the control device 11, the sphere generation device 12 and the point generation device 13.

Moreover, the multidimensional index generation apparatus may also be characterized by including clustering means for performing clustering by arranging identifiers specifying the object point in hierarchy based on the divided sphere.

In addition, the present invention provides a multidimensional index generation method of dividing a multidimensional space into a plurality of areas and generating a multidimensional index in association with the divided area, which includes a reference regular simplex arrangement step of arranging a regular simplex to be a reference in a certain position in the multidimensional space and a sphere arrangement step of arranging a sphere at a vertex of the regular simplex arranged by the reference regular simplex arrangement step and dividing the multidimensional space by the sphere.

According to the present invention, a space can be clustered efficiently even in a higher dimension, and speed-up of retrieval processing in a higher dimension can be realized.

In addition, the present invention provides an approximate information preparation apparatus for, in retrieving a predetermined point in a multidimensional space registered as a position in the multidimensional space, preparing approximate information obtained by approximating positional information concerning the registered point in the multidimensional space in order to reduce the number of times of access to the positional information concerning the registered point in the multidimensional space, which includes vector setting means for setting a set of direction vectors representing a direction in the multidimensional space and, at the same time, setting a predetermined direction vector corresponding to the predetermined point using at least a part of the set of direction vectors, axial length calculating means for finding a length from an origin of the set predetermined direction vector to a closest point from the point on the predetermined direction vector as an axial length, distance calculating means for finding a length from the point to the closest point on the direction vector as a distance, and approximate information forming means for forming the approximate information based on a predetermined direction vector set by the vector setting means, an axial length calculated by the axial length calculating means and a distance calculated by the distance calculating means. Further, the approximate information preparation apparatus corresponds to the approximate information generation device in the embodiment of the present invention, and the axial length calculating means, the distance calculating means and the approximate information forming means are constituted by cooperation of an arithmetic unit such as a CPU and software.

Further, in the approximate information preparation apparatus of the present invention, the approximate information forming means may be characterized by using a sphere formed by a direction vector set by the vector setting means, an axial length calculated by the axial length calculating means and a radius consisting of a distance calculated by the distance calculating means to form approximate information on a point.

In addition, in the approximate information preparation apparatus of the present invention, the approximate information forming means is characterized by using a circumference formed by a direction vector set by the vector setting means, an axial length calculated by the axial length calculating means, and a radius consisting of a distance calculated by the distance calculating means to form approximate information on a point.

In the approximate information preparation apparatus of the present invention, the approximate information forming means may be characterized by using a circumference of a cube formed by a direction vector set by the vector setting means, an axial length calculated by the axial length calculating means and a radius consisting of a distance calculated by the distance calculating means to form approximate information on a point.

Moreover, in the approximate information preparation apparatus of the present invention, the approximate information forming means may be characterized by using a circumference of a regular quadrangle formed by a direction vector set by the vector setting means, an axial length calculated by the axial length calculating means and a length consisting of a distance calculated by the distance calculating means to form approximate information on a point.

Moreover, in the approximate information preparation apparatus of the present invention, the approximate information forming means may also be characterized by using the quantized axial length and distance to form approximate information.

Moreover, in the approximate information preparation apparatus of the present invention, the vector setting means may be characterized by setting the direction vector based on each coordinate value in the case in which a predetermined point in the multidimensional space is represented by rectangular coordinates and, at the same time, setting the predetermined direction vector.

In addition, in the approximate information preparation apparatus of the present invention, the vector setting means is characterized by arranging a regular simplex in the multidimensional space, and using vertex vectors as a vector from the center of gravity of the regular simplex to a vertex of all or at least a part of the regular simplex to set the direction vector and, at the same time, setting the predetermined vector.

Further, in the approximate information preparation apparatus of the present invention, the vector setting means may be characterized by further setting a vector formed by combining the vertex vectors to set the direction vector.

In addition, the approximate information preparation apparatus of the present invention may also be characterized in that the vertex vectors and a vector formed by using the vertex vectors are normalized.

Moreover, in the approximate information preparation apparatus of the present invention, the vector setting means is characterized by including means for arranging a regular simplex in the multidimensional space, selecting k(k<=n) vectors v(i(1)), v(i(2)), . . . , v(i(k)) in order from one having a smallest argument with an object vector out of vertex vectors as vectors from the center of gravity of the regular simplex to the vertex of the regular simplex, and finding vectors g(1), g(2), . . . , g(k) as

g(1)=v(i(1))

g(2) (v(i(1))+v(i(2))/2

. . .

g(k)=(v(i(1))+v(i(2))+ . . . +v(i(k)))/k,

means for finding a vector g=n((g(1)+g(2)+ . . . +g(k))/k) that is obtained by normalizing vectors to centers of gravity of g(1), g(2), . . . , g(k) to set them as direction vectors, and means for using numbers i(1), i(2), . . . , i(k) of vertex vectors as the predetermined vector to set the predetermined vector.

Moreover, in the approximate information preparation apparatus of the present invention, the vector setting means is characterized by including means for arranging a regular simplex in the multidimensional space, selecting k(k<=n) vectors v(i(1)), v(i(2)), . . . , v(i(k)) in order from one having a smallest argument with an object vector out of vertex vectors as vectors from the center of gravity of the regular simplex to the vertex of the regular simplex, and finding vectors g(1), g(2), , g(k) as

g(1)=n(v(i(1)))

g(2)=n((v(i(1))+v(i(2))/2)

. . .

g(k)=n((v(i(1))+v(i(2))+ . . . +v(i(k)))/k), and

means for, based on g(1), g(2), . . . , g(k), finding a vector g(i) having a smallest argument with an object vector among them, finding a vector m(j) from the origin 0 to a midpoint of g(j) (j≠i) and g(i) as

m(j)=(g(i)+g(j))/2,

finding a vector group g(1), g(2), . . . , g(k) found by normalizing this m(j), and repeating this processing t times and, thereafter, setting a direction vector by finding the center of gravity g of g(1), g(2), . . . , g(k) and normalizing the center of gravity g, and setting the predetermined vector by a set of (j1, j2, . . . , jt).

Moreover, in the approximate information preparation apparatus of the present invention, the vector setting means may also be characterized by using an angle to set the direction vector.

Moreover, in the approximate information preparation apparatus of the present invention, if a point on a spherical surface in an n-dimensional space is represented by

(θ, φ(3), φ(4), . . . ,φ(n))

0<=θ<=2π

−π/2<=φ(i)<=π/2 (3<=i<=n)

with φ(i) as an angle in an i-dimension, the vector setting means may also be characterized by setting a direction vector and, at the same time, setting the predetermined vector by quantizing angles θ and φ(i).

Moreover, in the approximate information preparation apparatus of the present invention, the vector setting means may be characterized by, assuming that

A=π/(2\hat{ }a)

B=π/(2\hat{ }b),

further associating j satisfying jA<=θ<(j+1)A (0<=j<2\hat{ }a) with θ and k(i) satisfying k(i)A<=φ(i)+π/2<(k(i)+1)A (0<=k(i)<2\hat{ }b) with φ(i) to set a direction vector and, at the same time, setting the predetermined vector by c=(j, k(3), k(4), . . . , k(n)).

In addition, in the approximate information preparation apparatus of the present invention, the vector setting means is characterized by setting a direction vector by recursively dividing a dimension of a vector obtained by normalizing an object vector as a vector representing the predetermined point, constituting an identifier using a ratio of length, and assigning bits such that a surface area of a divided sphere and the number according to a bit assigned to a divided vector are proportional to each other.

In addition, the present invention provides an approximate information preparation method of, in retrieving a predetermined point in a multidimensional space registered as a position in the multidimensional space, preparing approximate information obtained by approximating positional information concerning the registered point in the multidimensional space in order to reduce the number of times of access to the positional information concerning the registered point in the multidimensional space, which includes a vector setting step of setting a set of direction vectors representing a direction in the multidimensional space and, at the same time, setting a predetermined direction vector corresponding to the predetermined point using at least a part of the set of direction vectors, a step of finding a length from an origin of the set predetermined direction vector to a closest point from the point on the predetermined direction vector as an axial length and finding a length from the point to the closest point on the direction vector as a distance, and an approximate information forming step of forming the approximate information based on a predetermined direction vector set by the vector setting step, a calculated axial length and a calculated distance calculated by the step of finding an axial length and a distance.

According to the present invention, approximate information can be stored without waste and as shorter information, an entire storage space can be reduced, and similarity retrieval that is capable of reducing the number of times of access of processing such as retrieval can be performed.

In addition, the present invention provides a retrieval apparatus that retrieves an item identical with or similar to a designated one from a memory unit storing a plurality of objects, which includes a multidimensional index generation unit for dividing a multidimensional space into a plurality of areas to generate a multidimensional index in association with the divided areas in order to specify a predetermined object in the multidimensional space, the multidimensional index generation unit including reference regular simplex arranging means for arranging a regular simplex to be a reference in a certain position in the multidimensional space and sphere arranging means for arranging a sphere at a vertex of the regular simplex arranged by the reference regular simplex arranging means and dividing the multidimensional space by the sphere, and a retrieval unit for using a multidimensional index generated by the multidimensional index generation unit to retrieve the object.

In addition, in the retrieval apparatus of the present invention, the multidimensional index generation unit is characterized by including an approximate information preparation unit for, in retrieving a predetermined point in a multidimensional space that is registered as a position in the multidimensional space, preparing approximate information that is obtained by approximating positional information concerning the registered point in the multidimensional space in order to reduce the number of times of access to positional information concerning the registered point in the multidimensional space.

Moreover, in the retrieval apparatus of the present invention, the approximate information preparation unit may be characterized by including vector setting means for setting a set of direction vectors representing a direction in the multidimensional space and, at the same time, setting a predetermined direction vector corresponding to the predetermined point using at least a part of the set of direction vectors, axial length calculating means for finding a length from an origin of the set predetermined direction vector to a closest point from the point on the predetermined direction vector as an axial length, distance calculating means for finding a length from the point to the closest point on the direction vector as a distance, and approximate information forming means for forming the approximate information based on a predetermined direction vector set by the vector setting means, an axial length calculated by the axial length calculating means and a distance calculated by the distance calculating means.

According to the present invention, a retrieval apparatus that is capable of realizing speed-up of processing of the retrieval apparatus and cost reduction can be provided.

Further, in this embodiment, there is disclosed a multidimensional index generation program for dividing a multidimensional space into a plurality of areas and generating a multidimensional index in association with the divided areas, which is stored in a computer readable storage medium, the multidimensional index generation program causing a computer to execute a reference regular simplex arrangement step of arranging a regular simplex to be a reference in a certain position in the multidimensional space and a sphere arrangement step of arranging a sphere at a vertex of the regular simplex arranged by the reference regular simplex arrangement step and dividing the multidimensional space by the sphere.

In addition, in this embodiment, there is disclosed an approximate information preparation program for, in retrieving a predetermined point in a multidimensional space registered as a position in the multidimensional space, preparing approximate information obtained by approximating positional information concerning the registered point in the multidimensional space in order to reduce the number of times of access to the positional information concerning the registered point in the multidimensional space, which is stored in a computer readable storage medium, the approximate information preparation program causing a computer to execute a vector setting step of setting a set of direction vectors representing a direction in the multidimensional space and, at the same time, setting a predetermined direction vector corresponding to the predetermined point using at least a part of the set of direction vectors, a step of finding a length from an origin of the set predetermined direction vector to a closest point from the point on the predetermined direction vector as an axial length and finding a length from the point to the closest point on the direction vector as a distance, and an approximate information forming step of forming the approximate information based on a predetermined direction vector set by the vector setting step, a calculated axial length and a calculated distance calculated by the step of finding an axial length and a distance. In this case, the computer readable medium includes portable storage media such as a CD-ROM, a flexible disk, a DVD disk, a magneto-optical disk and an IC card, a database for holding a computer program, or other computers and a database therefor, and a transmission medium on a line.

### BRIEF DESCRIPTION OF THE DRAWINGS

FIG. 1 is a block diagram showing a system configuration in an embodiment of the present invention;

FIG. 2A is a diagram showing a relationship between a regular simplex and a sphere and represents basics of a regular sphere arrangement in the case of a two-dimension;

FIG. 2B is a diagram showing a relationship between a regular simplex and a sphere and represents the basics of a regular sphere arrangement in the case of a three-dimension;

FIG. 3A is a diagram showing a relationship between a vertex vector and a surface vector in the case of the two-dimension;

FIG. 3B is a diagram showing a relationship between a vertex vector and a surface vector in the case of the three-dimension;

FIG. 4 is a diagram showing covering by a circle of a two-dimensional plane;

FIG. 5 is a diagram showing a relationship between a circle and a regular triangle and shows a regular arrangement of a sphere in the two-dimension;

FIG. 6A is a table showing a point relation in which each coordinate value is stored in each field;

FIG. 6B is a table showing a point relation in which coordinate values are stored collectively in one field as an array;

FIG. 7 is a table showing storage of coordinates by an array and shows how coordinate values are specifically arranged as an array in FIG. 6B;

FIG. 8 is a table showing an index relation for a flat structure;

FIG. 9A is a table showing storage of information on points by an array, which shows a variable length array with information on each point as an element;

FIG. 9B is a table showing storage of information on points by an array, which shows how each element is stored;

FIG. 10 is a diagram showing an image of a hierarchical structure of a sphere;

FIG. 11A is a diagram showing a basic division in the case of the two-dimension;

FIG. 11B is a diagram showing a basic division in the case of the three-dimension;

FIG. 12 is a diagram showing an extended division;

FIG. 13A is a table showing a growth record in the case in which a child sphere coincides with a vertex sphere;

FIG. 13B is a table showing a general growth record;

FIG. 14 is a table showing an index relation for realizing a hierarchy;

FIG. 15A is a table showing storage by an array of information on a child sphere, which shows a variable length array of information on a child sphere;

FIG. 15B is a table showing storage by an array of information on a child sphere, which specifically shows elements of the array;

FIG. 16 is a diagram showing a hierarchical structure of index records and point records;

FIG. 17 is a table showing hierarchical identifier used for facilitating clustering on a secondary memory of records;

FIG. 18 is a table showing an index relation for realizing a hierarchy;

FIG. 19 is a flow chart showing a flow at the time of generation of a multidimensional index;

FIG. 20A is a graph showing a representation of a point by a direction, which shows a polar coordinate representation;

FIG. 20B is a graph showing a representation of a point by a direction, which shows a direction vector and a radius ratio;

FIG. 21 is a graph showing a relationship between a point and a direction vector;

FIG. 22 is a graph showing approximation by a spherical surface;

FIG. 23 is a graph showing approximation by a circumference;

FIG. 24 shows a circumference corresponding to each point;

FIG. 25 is a graph showing approximation by a solid surface;

FIG. 26 is a graph showing approximation by a square circumference;

FIG. 27 is a graph showing a relationship between a circumference and vicinity;

FIG. 28 is a graph showing uniform direction vectors;

FIG. 29 is a graph showing a regular simplex and direction vectors;

FIG. 30A is a graph showing the center of gravity string based on a three-dimensional regular simplex;

FIG. 30B is a graph of a part of a regular triangle ABC extracted from FIG. 30A;

FIG. 31 is a graph showing a representation of a point on a three-dimensional spherical surface by an angle;

FIG. 32 is a graph showing recursive dimension division;

FIG. 33 is a graph showing approximation by a circumference of a sphere;

FIG. 34 is a flow chart showing a flow of range retrieval;

FIG. 35 is a graph showing a relationship between a center of approximation and vicinity;

FIG. 36 is a flow chart showing a flow of ranking retrieval;

FIG. 37A is a diagram showing a sphere and a circum solid in the case of the two-dimension;

FIG. 37B is a diagram showing a sphere and a circum solid in the case of the three-dimension; and

FIG. 38 is a graph representing approximation by rectangular coordinates of points in a circle.

### DETAILED DESCRIPTION OF THE PREFERRED EMBODIMENTS

Embodiments of the present invention will be hereinafter described with reference to the accompanying drawings.

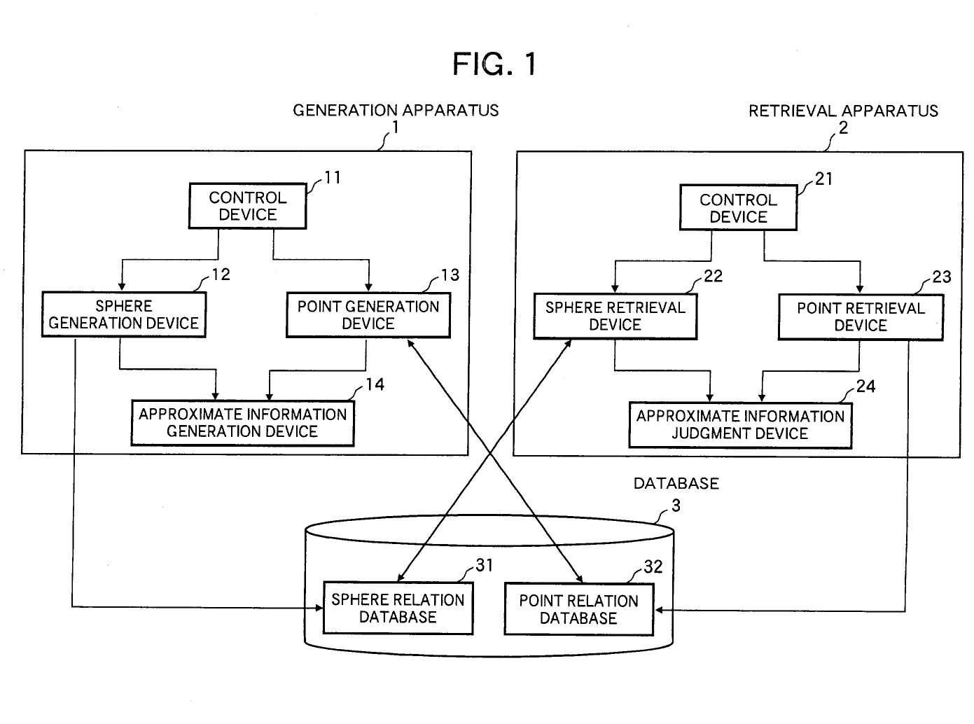

FIG. 1 is a functional block diagram showing a system configuration of a similarity retrieval apparatus (retrieval apparatus) in an embodiment of the present invention.

The similarity retrieval apparatus of the embodiment consists of a generation apparatus 1 for performing generation and update of a multidimensional index, a retrieval apparatus (similarity retrieval apparatus) 2 for using a generated multidimensional index to perform similarity retrieval and, at the same time, using approximate information to perform filtering processing, and a database 3.

The generation apparatus 1 is constituted by a control device 11, a sphere generation device 12, a point generation device 13 and an approximate information generation device 14. The control device 11 performs control of the entire generation and update. The sphere generation device 12 performs generation, update and deletion of a sphere as well as generation, update and deletion of an index relation and an index record corresponding thereto. The point generation device 13 performs generation and deletion of a point as well as generation and deletion of a point relation and a point record corresponding thereto. The approximate information generation device (approximate information preparation apparatus) 14 generates approximate information corresponding to a point or a sphere.

The retrieval apparatus 2 is constituted by a control device 21, a sphere retrieval device 22, a point retrieval device 23 and an approximate information judgment device 24. The control device 21 performs control of the entire similarity retrieval. The sphere retrieval device 22 performs retrieval of a sphere and access to an index relation associated therewith. The point retrieval device 23 performs retrieval of a point and access to a point relation associated therewith. The point approximate information judgment device 24 judges whether or not a point or a sphere intersects vicinity from approximate information corresponding to the point or the sphere. Further, the point approximate information judgment device 24 performs the judgment for update and deletion.

The database 3 is constituted by a sphere relation database 31 for storing a sphere relation and a point relation database 32 for storing a point relation. Preparation (establishment) of a multidimensional index, preparation of approximate information and similarity retrieval (retrieval), all of which are executed in this apparatus, will be hereinafter described.

I. Establishment of a Multidimensional Index

In a multidimensional index method, first, how to constitute a multidimensional index is important. It will be hereinafter described how a multidimensional index is established by a generation apparatus.

1) Association of a Point and a Sphere

It is assumed that any distance from the center of gravity of a regular simplex to each vertex is equal and this distance is referred to as a radius of the regular simplex. Actually, this distance is a radius of a circum sphere of the regular simplex and should be referred to as a radius of the circum sphere of the regular simplex. However, it is simply referred to as the radius of the regular simplex.

In addition, a sphere with a vertex of a regular simplex as a center and with a radius of the regular simplex as a radius is referred to as a vertex sphere of the regular simplex. Since there are n+1 vertexes in an n-dimensional regular simplex, n+1 vertex spheres exist.

1.1) Basic Division

FIG. 2A is a diagram in which a circle is arranged at each vertex of a regular triangle. A radius of the circle is a distance from the center of gravity G of the regular triangle to the vertex. In this way, a space near the regular triangle can be covered without a gap or with minimum overlapping of circles. Similarly, FIG. 2B is a diagram in which a sphere is arranged at each vertex of a regular tetrahedron. As in FIG. 2A, a radius of the sphere is a distance from the center of gravity of the regular tetrahedron to the vertex. In this case, a space near the regular tetrahedron can also be covered without a gap and with minimum overlapping of spheres. A sphere is arranged at each vertex of a regular simplex in the same manner in the case of the four-dimension or more. A radius of the sphere is a distance from the center of gravity of the regular simplex to the vertex. In this case, a space can also be covered without a space and with minimum overlapping of spheres.

<1> Now, it is considered to cover the following set of points with this method:

P={p(1), p(2), . . . , p(M)}.

First, when a position and a radius of a regular simplex are determined adequately, each point p(i) can be included in any sphere with a vertex of the regular simplex as a center. The regular simplex determined in this way is referred to as a reference regular simplex of basic division. Then, the following set of spheres covering the set of points is determined as described below:

S={S(1), S(2), . . . , S(k)}

S(j) is a vertex sphere of the reference regular simplex, and a maximum value of k is n+1 and minimum value of k is 1. This S is determined as follows. At first, S is an empty set. Then, the following processing is applied to each point p(i):

<2> Check if spheres included in S include the point p(i) in the order of S(1), S(2), and so on.

<3> If a sphere includes the point p(i), place the point p(i) in the sphere.

<4> If a sphere does not include the point p(i), find a vertex of the regular simplex closest to p(i), generate a sphere with the vertex as a center, that is, a vertex sphere, place the point p(i) in the sphere, and place the sphere in S. A method of dividing the set of points P into spheres in this way is referred to as a basic division.

1.2) Extended Division

First, new terms used herein will be described.

A vector from the center of gravity of a regular simplex to each vertex is referred to as a vertex vector. A reverse vector (vector with the same length and a reverse direction) of this vertex vector is referred to as a surface vector. A surface (n+1-dimensional space actually) of the regular simplex intersecting this surface vector is referred to as a surface corresponding to this surface vector.

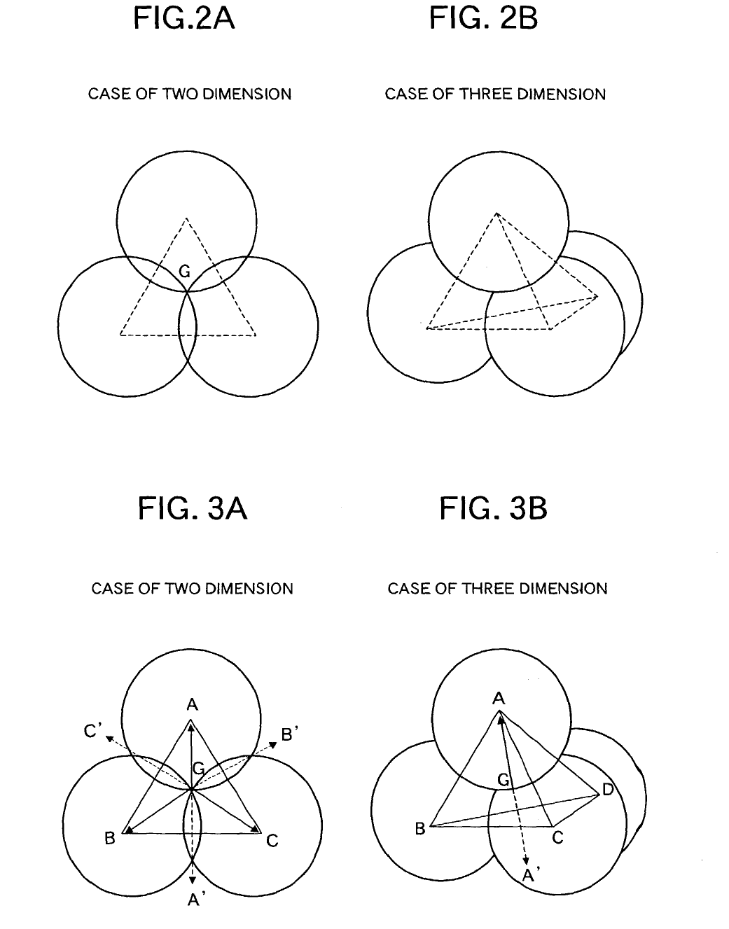

FIG. 3A illustrates the case of the two-dimension. Reference character G denotes the center of gravity of a regular triangle, and reference numerals A, B and C denote vertexes. Vectors GA, GB and GC are vertex vectors. Vectors in the reverse direction, GA′, GB′ and GC′ are surface vectors. The surface vectors intersect sides BC, CA and AB, respectively. These are sides in the two-dimension but are surfaces in the three-dimension. In general, in n-dimension or more, these are n+1-dimensional surfaces. In this sense, they are referred to as surface vectors rather than side vectors. This side (in general, surface) is a side (in general, surface) corresponding to the surface vector.

FIG. 3B also shows the case of three-dimension. In the figure, a vertex vector and a surface vector are shown only for the vertex A.

Here, a vector from the center of gravity of the regular simplex in question to a point is referred to as a center of gravity to point vector. In addition, a surface vector with the smallest angle with respect to the center of gravity to point vector among n+1 surface vectors of the regular simplex is found, and a new regular simplex is connected to a surface corresponding to this surface vector such that surfaces match each other well. In this way, new regular simplexes are created one after another. This is called growth of a regular simplex. Every time a regular simplex grows, a newly generated regular simplex approaches the point. In the basic division, the number of spheres is n+1 at the maximum, and a size of a sphere is generally large. A radius of a sphere is restricted by a distribution of a set of points.

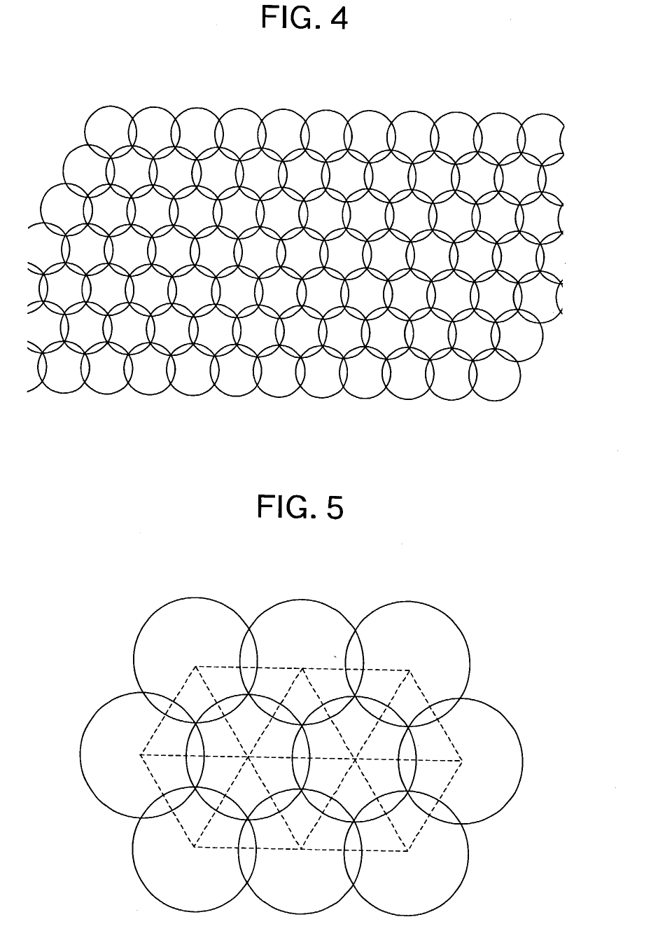

Next, a method of dividing a space by a sphere of an arbitrary radius will be described more generally. FIG. 4 is a diagram showing the case of the two-dimension. In this figure, as it is well known, a two-dimensional space (plane) is covered by circles of the same radius without a gap and with least overlapping. FIG. 5 is a diagram in which a part of FIG. 4 is extracted and centers of the circles are connected by lines. When observed well, in this figure, regular triangles are regularly arranged and circles are arranged at vertexes thereof. This arrangement of regular triangles is attained by placing one regular triangle to be a reference first and subsequently attaching regular triangles such that sides of the regular triangles match each other.

In the case of the three-dimension, this cannot be attained so simply as in the case of the two-dimension. This is because, if a regular tetrahedron of the same size is attached to one regular tetrahedron to be a reference as in the case of the two-dimension such that surfaces match each other, a gap is generated between the regular tetrahedrons. It is known that, if five regular tetrahedrons are connected so as to draw a circle, a gap of approximately 10 degrees is generated between a first regular tetrahedron and a last regular tetrahedron. If it is attempted to draw more circles, the circles do not completely match the regular tetrahedron to be a reference but intersect it. That is, the three-dimensional space cannot be covered by regular tetrahedrons without overlapping as in the case of the two-dimension. In the three-dimension, the question of what is an arrangement without a gap and with least overlapping has been unsolved for nearly 400 years. Recently, it seems that a most densely filled structure (usually, a method adopted in filling balls in a box) has been proved to be most suitable.

In the embodiment of the present invention, the next regular simplex is connected such that its surface coincides with a surface of a regular simplex taking into account the fact that a space cannot be completely covered by a regular simplex as described above. Then, a set of points is divided by a set of spheres with a method described below.

<1> It is considered to cover the following set of points as in the case of the basic division:

P={p(1), p(2), . . . , p(m)}.

First, a position and a radius of a regular simplex is appropriately decided. This regular simplex is referred to as a reference regular simplex of the extended division. In this case, a certain point p(i) may not be included in a sphere having as its center any one of vertexes of the reference regular simplex as it is in the basic division. Then, the following set of spheres covering the set of points is decided as described below:

S={S(1), S(2), . . . , S(k)}.

A value of k is m at the maximum and 1 at the minimum. This S is decided as described below. S is an empty set at first. Then, the following processing is applied to each point p(i):

<2> Check if spheres included in S include the point p(i) in the order of S(1), S(2), and so on.

<3> If a sphere includes the point p(i), place the point p(i) in the sphere.

<4> If a sphere does not include the point p(i), first, check if it is included in any one of the vertex spheres of the reference regular simplex. If it is included, generate a sphere, place the point in the sphere and add the sphere in S.

If the point p(i) is not included in any vertex sphere, a sphere including the point p(i) is decided with a method of <5> below. Simply speaking, a regular simplex is connected in a certain direction of the point p(i).

<5> A surface vector with the smallest angle with respect to the center of gravity to point vector among n+1 surface vectors of the regular simplex is found, and a new regular simplex is connected to a surface corresponding to this surface vector such that surfaces match each other well.

<6> One vertex different from the vertexes of the original regular simplex is created in this new regular simplex. If the point is included in a vertex sphere with this vertex as a center, this sphere is a sphere to be found.

<7> If the point is not included in this sphere, the operations of <5>and <6>are continued until a certain sphere includes the point. Since the regular simplex approaches the point every time it grows, this processing ends by operations of limited times.

2) Flat Storage of Information on a Point and a Sphere

Here, it will be described how information on a point and a sphere is stored on a secondary memory.

The present invention is intended to be realized on an existing database system taking into account realizability. Therefore, it is required to be a record basis rather than a page basis. The existing database system will be described based on an example of storage in a relation database system currently used for commercial purposes most. Note that the present invention can be realized not only on the relation database system but also on an object-oriented database system. On the object-oriented database system, information is stored in a class instead of a relation.

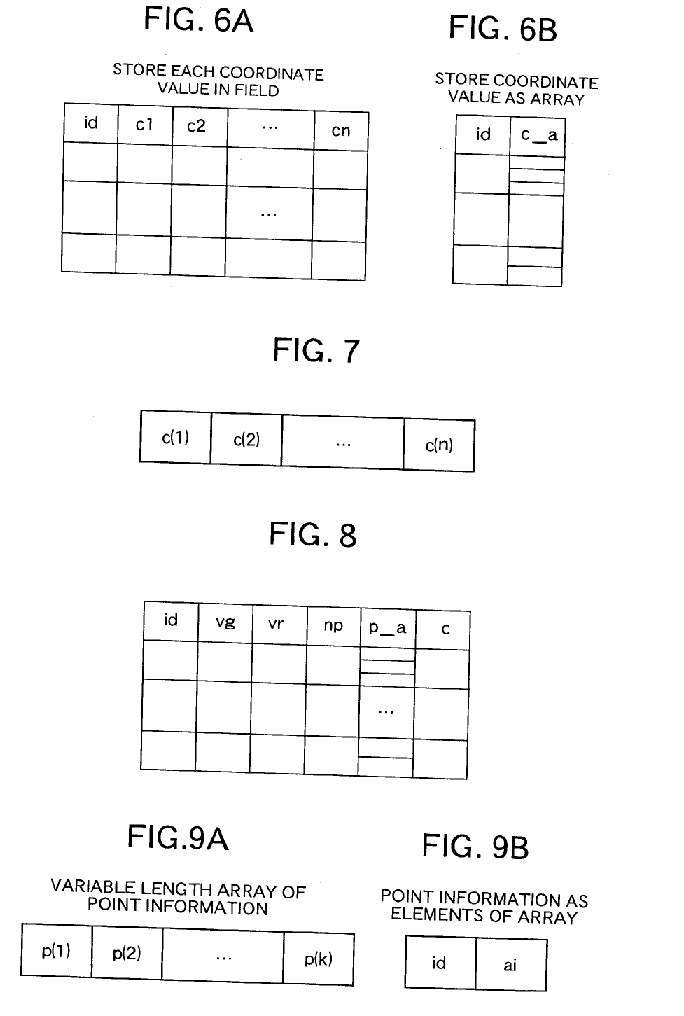

As shown in FIG. 6, information on a point is stored in a point relation. A relation may be considered as a table. Information on one point is stored in one record. Although a record is referred to as a tuple in a relation database, it is referred to as a record here. As information on a point, a coordinate value for each dimension is stored. In FIG. 6A, a coordinate value of each dimension is stored for each field. Association between information to be stored and a field name is as described below.

| Information to be stored | Field name | Remarks |
|---|---|---|
| Identifier | id | Index |
| Coordinate value of | ci(i = 1, 2, . . . , n) | |
| each field | | |

The point record is accessed with the identifier as a key. Therefore, an index (usually, by B-tree) is affixed to the id field in order to access at a high speed. Concerning other relations, an index is affixed to an identifier in the same manner. However, a coordinate value may be stored in one field as an array. FIG. 6B shows this. A field of a field c_a divided by horizontal lines represents that an array is stored. This realizes a higher speed. In addition, a number is stored in the id field as an identifier of a point. Association between information to be stored and a field name is as described below.

| Information to be stored | Field name | Remarks |
|---|---|---|
| Identifier | id | Index |
| Array of coordinate values | c_a | Array |

It is assumed that the array of coordinates has a structure of FIG. 7. n is the number of dimensions, and this array is a fixed length array. Therefore, it is sufficient to store the array as fixed length binary data. A function for storing the array in the relation database is not required.

Here, before explaining an index record, terms to be used anew will be explained first.

Now, when it is assumed that the center of gravity G of all points included in a sphere is

(X(1), X(2), . . . , X(n)), and

coordinates of each point p(i) are

(x (j, 1), x(j, 2), . . . , x(j, n)),

the following expression is obtained:

X(i)=Σ[j=1, k] x(j,j)/k.

That is, X(i) is an average of a coordinate value of an i dimension of each point. Here, k is the number of points included in the sphere. In addition, Σ[j=1, k] f(j) means a sum of f(1), f(2), . . . , f(k). When a distance to a point most distant from this center of gravity is assumed to be r, a set of points is included in a sphere having a radius r with the center of gravity G as its center. This sphere is referred to as a substantial sphere in that it is formed by the set of points substantially. In addition, the point G is referred to as a center of the substantial sphere and the radius r is referred to as a radius of the substantial sphere.

As opposed to this substantial sphere, the above-described sphere with the regular simplex as a reference is referred to as a regular sphere in that it is arranged regularly, or simply referred to as a sphere. Information on the sphere is also stored in the index relation as shown in FIG. 8. Information on one sphere is stored in one index record. Association between information to be stored and a field name is as described below.

| Information to be stored | Field name | Remarks |
|---|---|---|
| Identifier | id | Index |
| Center of gravity of | vg | |
| substantial sphere | | |
| Radius of substantial | vr | |
| sphere | | |
| Number of points included | np | |
| in a sphere | | |
| Array of points included in | p_a | Array |
| a sphere | | |
| [Center] | c | |

If a method described in 3.4) is adopted, the center is unnecessary. FIG. 9 shows how to store the field p_a. FIG. 9A shows a state of the storage realized by an array. k is the number of points included in a sphere, which is a value stored in the field np. Since k generally varies for each sphere, this array is a variable length array. Therefore, the field p_a is required to be stored as variable length binary data. This is because, if it is stored as fixed length binary data, waste of a space occurs in terms of efficiency. FIG. 9B represents information on each point as an element of the array. The information has an identifier id of a point record corresponding to a point and, in addition, approximate information ai. The index is eventually formed hierarchically. However, here, descriptions are made using the above-described index relation having a flat structure for the purpose of explanation.

2.1) Retrieval

If retrieval is performed, the index relation is scanned first. Then, it is judged whether or not a sphere and vicinity corresponding to each index record intersect. The judgment is performed according to the following two points:

a) Whether or not the Vicinity Intersects the Sphere

It can be easily judged whether or not the sphere intersects the vicinity based on a center of the sphere and a radius. This is because, when it is assumed that a distance between the sphere and the vicinity is d, a radius of the sphere is r, and a radius of the vicinity is R, a condition under which the sphere intersects the vicinity is as follows:

d<=r+R.

b) Whether or not the Vicinity Intersects the Substantial Sphere

It can be easily judged whether or not the substantial sphere and the vicinity intersect as in the case of a).

The vicinity intersects the sphere if both the conditions of a) and b) are established.

If the vicinity does not intersect the sphere, since points included in the sphere are not naturally included in the vicinity, it becomes unnecessary to check points in the sphere. This is an effect of an index.

It should be noted that a description “a sphere and vicinity intersect” means that the above-described conditions a) and b) are established.

3) Hierarchizing

In the structure of the flat index described above, all the spheres have to be checked. However, since the points are hierarchized, all the points have not to be checked and an area that should be checked is limited to the spheres that intersect the vicinity.

If this hierarchizing is applied to the index record rather than the point record, an area to be checked can be further limited. Basically, a sphere including a plurality of spheres is considered as a sphere including a plurality of points is considered. This hierarchizing will be hereinafter described. FIG. 10 is not an accurate drawing but shows an image of this hierarchizing. That is, FIG. 10 depicts an image showing what the hierarchizing by regular arrangement of spheres is like.

First, basic terms used anew will be described here.

Here, it is considered to divide an internal space of a sphere by a plurality of spheres. In this case, the dividing plurality of spheres are referred to as child spheres and the sphere to be an object of division is referred to as a parent sphere.

Further, the child sphere becomes an object of division, that is, a parent sphere and a child sphere that is its grandchild is created. In this way, a hierarchical structure of spheres is created. The uppermost sphere in this hierarchical structure is referred to as a root sphere. In addition, the lowermost sphere of the hierarchy, that is, a sphere that does not have child spheres is referred to as a leaf sphere. The spheres having child spheres including the root sphere are referred to as node spheres.

Then, points in a sphere Sd are divided with this regular simplex as a reference. Spheres created by dividing the points are referred to as child spheres. On the other hand, the sphere Sd is referred to as a parent sphere. The reference regular simplex is created for each parent sphere.

Here, it will be described in more detail in which child sphere the point is included.

First, it is considered that all points are included in one sphere. This sphere is assumed to be a root sphere. A center of the root sphere is placed in an appropriate position, and its radius is assumed to be a distance to a point most distant from the center. This sphere is divided into a plurality of spheres recursively. A method of dividing the sphere includes the two methods described in 1), that is, the basic division and the extended division. First, the method will be described based on the basic division. Note that the reference regular simplex is decided for each parent sphere.

3.1) Hierarchizing Based on the Basic Division

First, the sphere Sd to be an object of division is assumed to be a root sphere.

<1> The center of gravity of a reference regular simplex a is matched with the center of the sphere Sd. A method for obtaining a radius of the reference regular simplex σ is described below. A set of points included in the sphere Sd is assumed to be as follows:

P={p(1), p(2), . . . , p(m′)}.

A set of child spheres of the sphere Sd is assumed to be S and the number of generated child spheres is assumed to be k. At the present stage, S is an empty set and k equals zero. Processing of 2) below is applied to each point p(i) of P.

<2> Existing child spheres included in S are checked in the order of S(1), S(2), . . . , S(k) and, if there is a child sphere S(j) including p(i), p(i) is included in S(j).

<3> If there isn't a child sphere S(j) including p(i), a vertex sphere corresponding to a vertex of a reference regular simplex σ closest to p(i) is generated as S(k+1) anew and included therein. Since the number of child spheres has increased by one, a value of k is increased by one.

The sphere Sd is finally divided into k child spheres and a set of child spheres as shown below is generated.

S={S(1), S(2), . . . , S(k)}.

k takes a value of n+1 at the maximum. A smallest value is 1. By applying the above-mentioned operations of <1>, <2> and <3> to each child sphere S(j) recursively, more hierarchical indexes can be created.

Whether or not a sphere is divided into child spheres is decided according to the number of points included in the sphere. A certain threshold value is set and a sphere is divided if the number of points exceeds the threshold value. As a way of setting the threshold value, it is possible to make it a constant or a function of a dimension n.

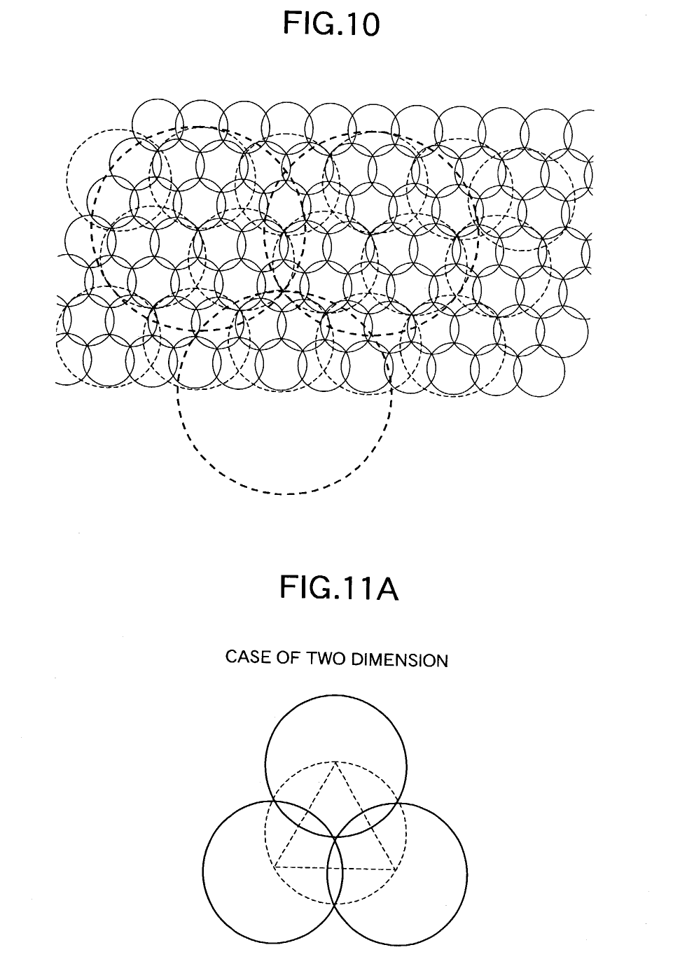

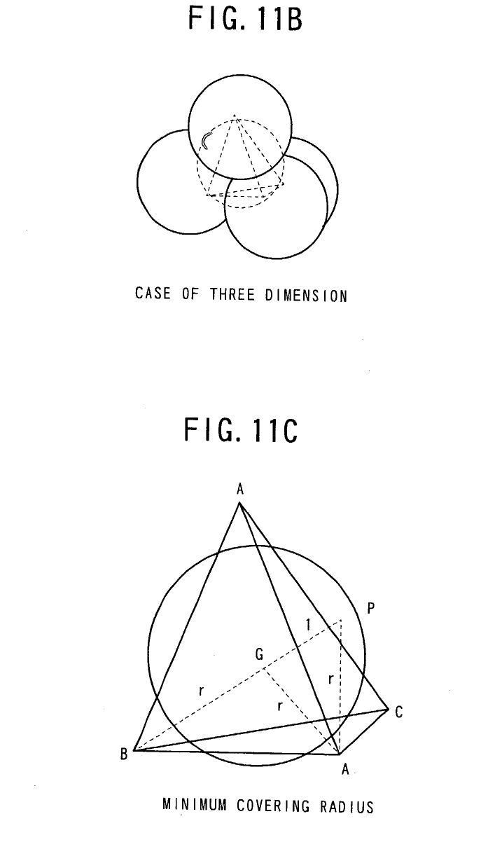

FIG. 11 shows this basic division. A circle and a sphere of dotted lines are divided by circles and spheres of solid lines. FIG. 11A shows the case of the two dimension and FIG. 11B shows the case of the three dimension.

Here, a method for obtaining a radius of the reference regular simplex σ is explained below. In case of two dimension, as shown in FIG. 11A, an original (root) sphere (expressed by using dotted line) can be covered without being left by 3 vertex spheres whose radius are equal to those of the original sphere (root sphere). Therefore the radius of the reference regular simplex should be equal to a radius of the original sphere.

In case of three dimension, if the radius of the reference regular simples σ is assumed to be equal to a radius of the original sphere, the sphere cannot be covered by 4 vertex spheres. Therefore the radius of the reference regular simplex must be made larger. This state is shown by FIG. 11B. In case of n (n=>4) dimension, the discussion is generally the same thing as mentioned above.

Here, in case of n (n=>3) dimension, a method for obtaining a radius of a reference regular simplex σ will be explained below.

In case of n dimension, n+1 vertex spheres become to be able to cover an original sphere completely by enlarging a radius of a reference regular simplex. A minimum value of the radius which the vertex spheres can cover an original sphere completely is referred to as a minimum covering radius and is represented by rmin.

A method for obtaining rmin is explained by using FIG. 11C. FIG. 11C shows three dimension case. Here, a sphere of which scale of radius is 1 and of which center point is G is assumed.

It is assumed that the sphere is arranged such that the center point G is coincided with a center point of gravity of a regular simplex (FIG. 11C shows a regular tetrahedron).

Further, with r as a radius of the regular simplex, it is assumed that r is larger than 1.

Here, it is assumed that an enlarged line segment BG intersects the sphere. The intersection is assumed to be P.

Then, P is located on a surface of the sphere and is located on the furthest point from 3 vertex A, B, C of all points on the sphere.

Therefore, if the vertex sphere of which center point coincides the vertex A and of which radius is r includes point P, 4 vertex spheres become to be able to cover the sphere.

Here, in case of obtaining minimum radius of a reference regular simplex which can cover the sphere, the minimum covering radius rmin is determined as r if AG becomes to be equal to AP, ie. the vertex sphere can just cover the point P. FIG. 11C shows a case which a length of a line segment just becomes to be equal to that of a radius r, i.e. r becomes to be equal to rmin. 3.2) Hierarchizing based on the extended division

With the hierarchizing by the basic division, all radiuses of child spheres are equal to a radius of a root sphere or larger than a radius of a root sphere. Therefore, a large sphere is created. The large sphere has a disadvantage that it tends to intersect vicinity. Thus, it is possible to divide it into child spheres with a smaller radius.

When a radius of a child sphere is assumed to be r, all points included in a parent sphere are not always covered by n+1 child spheres. In this case, the above-mentioned extended division is used. A detailed procedure of the extended division is as described below. A method of deciding a center and a radius of a root sphere is the same as that in the case of the basic division.

First, the sphere Sd to be an object of division is assumed to be a root sphere.

<1> The center of gravity of a reference regular simplex σ is matched with the center of the sphere Sd. A radius of the reference regular simplex σ is made equal to the radius of the sphere Sd or larger than a radius of a root sphere. A set of points included in the sphere Sd is assumed to be as follows:

P={p(1), p(2), . . . , p(m′)}.

A set of child spheres of the sphere Sd is assumed to be S and the number of generated child spheres is assumed to be k. At the present stage, S is an empty set and k equals zero. Processing of 2) below is applied to each point p(i) of P.

<2> Existing child spheres included in S are checked in the order of S(1), S(2), . . . , S(k) and, if there is a child sphere S(j) including p(i), p(i) is included in s).

<3> If there isn't a child sphere, first, it is checked if p(i) is included in the vertex sphere of the reference regular simplex σ. If it p(i) is included, the sphere is a child sphere to be found. The sphere is generated as S(k+1) and the point is included therein. Then, a value of k is increased by one.

<4> If the point p(i) is not included in any vertex sphere, a sphere S(k+1) found first including the point is generated as the regular simplex grows, and the point is included therein. Then, a value of k is increased by one. The sphere Sd is finally divided into k child spheres and a set of child spheres as shown below is generated.

S={S(1), S(2), . , S(k)}.

k takes a value of m′ at the maximum. A smallest value is 1.

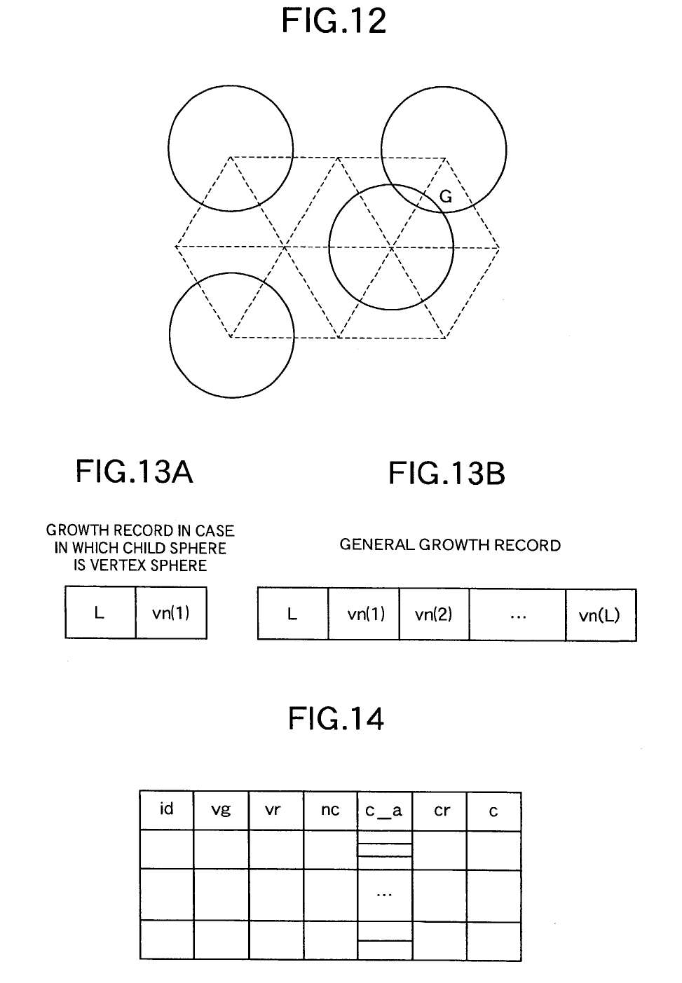

By applying the above-mentioned operations of <1> to <4> to each child sphere S(j) recursively, more hierarchical indexes can be created. A criterion for judging whether or not a sphere is divided is the same as the case of the basic division. FIG. 12 shows this extended division in the case of the two dimension. A point G is assumed to be the center of gravity of a reference regular simplex. In this figure, two vertex spheres are created, and other two spheres are also generated.

3.3) A Method of Matching the Center of gravity of Data with the Center of Gravity of a Reference Regular Simplex

The present invention has been described on the premise that the center of gravity of the reference regular simplex is matched with a center of a parent sphere for ease of description. However, points included in the parent sphere are not always distributed around the center of the parent sphere. The points are likely to gather in a specific part of the parent sphere. In this case, the parent sphere is likely to be divided into a small number of spheres (one child sphere in the worst case). Thus, a method is possible which sets the center of gravity of a set of points included in the parent sphere, that is, a center of a substantial sphere as a center of the reference regular simplex. In this case, with the above-mentioned method of the basic division, a situation may occur in which a point is not included (left out) in any child sphere. This is because a parent sphere is divided without any gap by the basic division only when a center of the sphere and the center of gravity of a reference regular simplex coincide with each other. Therefore, in this method, the extended division is always used. Note that it is possible to use the basic division unnaturally by enlarging a radius of a reference regular simplex. However, this is unadvisable because a radius of a child sphere is larger than a parent sphere in this case.

3.4) Method of not Giving a Center of a Sphere

Here, a ratio r/R of a radius r of a child sphere with respect to a radius R of a parent sphere is referred to as a parent and child radius ratio. In addition, if a child sphere is decided according to growth of a regular simplex, the number of times of connection of regular simplexes starting from a reference regular simplex is referred to as a length of growth. The closer the parent and child radius ratio to 1, the less likely the growth of a regular simplex occurs. Even if the growth occurs, the length of the growth is small.

Now, in generating a child sphere, a generation process is recorded according to variable data called a generation record shown in FIG. 13 as described below. Note that n+1 vertex vectors of the reference regular simplex are denoted by numbers from 0 to n. L represents a length of growth. If a child sphere is a vertex sphere, L is considered to be zero. In this case, the growth record is as shown in FIG. 13A. vn (1) is a number of a vertex of the vertex sphere. L is set to zero rather than 1 in order to distinguish the growth from the next growth.

In the case of growth, vertex numbers vn(1), vn(2), . . . , vn(L) of a length of growth are affixed after L as shown in FIG. 13B. FIG. 13B represents a general growth record. The number vn(i) is decided as described below. vn(1) is a number of a vertex corresponding to a surface vector in the first connection to the reference regular simplex, that is, corresponding to a vertex vector to be reverse vector.

When a regular simplex is connected, n vertexes among n+1 vertexes of the connected regular simplex coincide with vertexes of an original regular simplex in the case of the n dimension. Only one vertex is different. Utilizing this phenomenon, the vertexes of the connected regular simplex coinciding with the original vertexes are denoted by the same numbers as those of the original vertex, and one different vertex is denoted by the number of the remaining vertex of the original regular simplex. Then, vn(2) and the subsequent numbers are also decided by the same method as deciding vn(1).

A growth process of the regular simplex can be traced from the growth record decided in this way. Therefore, a center of a child sphere corresponding to the growth record can be calculated. Therefore, if there is the growth record, the center of the child sphere can be found without accessing an index record corresponding to the child sphere, and the number of times of access to the index record can be reduced. A data length of the growth record is only L+1 bytes even if one byte is assigned to L and one byte is assigned to each vn(i). On the other hand, the center of the sphere is generally far larger than this size. Therefore, it is hardly a burden to hold this growth record in a parent index record if the parent and child radius ratio is close to 1. Further, this method can be applied until a parent and child radius ratio becomes higher when this method is adopted.

4) Hierarchized Storage of Information on Points and Spheres

A method of storing information in a flat structure is described in 2). Here, it will be described how information is stored including hierarchizing in 3). The point record and the point relation are completely the same as those in 2).

An index relation is as described below.

Information on a sphere is also stored in the index relation as shown in FIG. 14. Information on one sphere is stored in one index record. Association between information to be stored and a field name is as follows:

| Information to be stored | Field name | Remarks |
|---|---|---|
| Identifier | id | Index |
| Center of gravity of | vg | |
| a substantial sphere | | |
| Radius of a substantial | vr | |
| sphere | | |
| Number of points/spheres | nc | |
| included in a sphere | | |
| Array for points/spheres | c_a | Array |
| included in a sphere | | |
| Radius of a child sphere | cr | |
| (zero in the case of | | |
| a leaf sphere) | | |
| [Center] | c | |

If the method described in 3.4) is adopted, it is unnecessary to give a center.

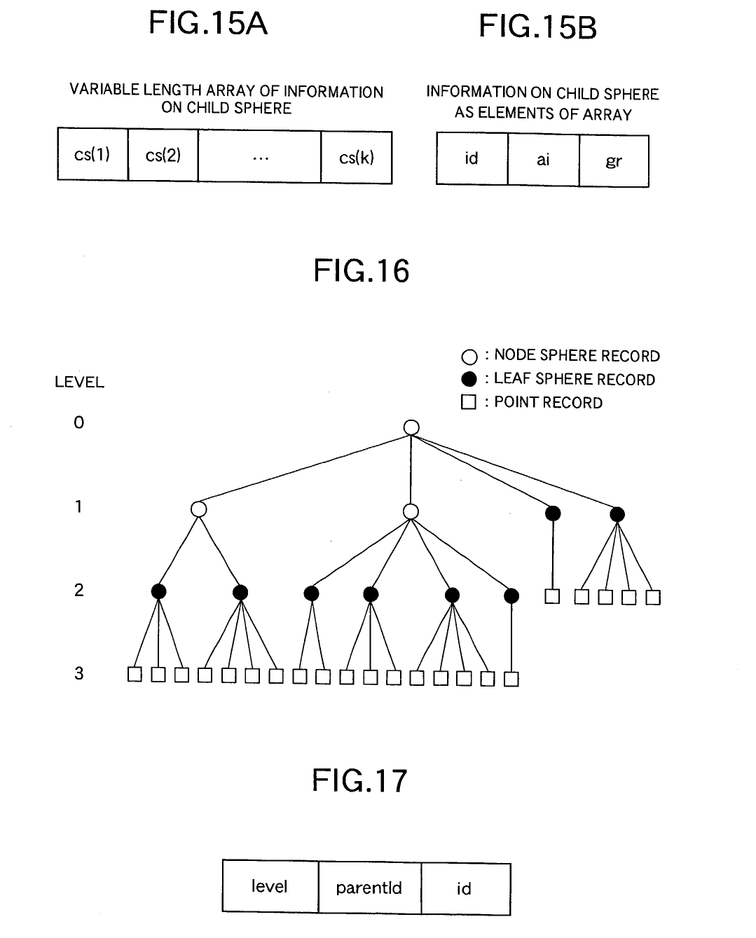

Distinction on whether a sphere is a node sphere or a leaf sphere can be judged based on whether or not a value of a cr field is zero. In the case of the leaf sphere, a variable length array of the information on the points shown in FIG. 9 is stored. In the case of the node sphere, information on a child sphere shown in FIG. 15 is stored. As a whole, each element shown in FIG. 15A is realized as a variable length array having information on the child sphere. As shown in FIG. 15B, as information on each child sphere, an identifier (id), approximate information (ai) and a growth record (gr) of the child sphere are stored.

If a parent and child relation ratio is smaller than 1 and a growth record does not have meaning, this growth record is not stored. FIG. 16 illustrates a hierarchical structure of index records and point records stored in this way. Here, a depth from a root of each hierarchy is referred to as a level. The level of a root increases by one as the depth increases by 0, 1, and so on.

5) Clustering of a Record

Since the present invention is considered on a record basis, clustering cannot be controlled freely compared with a method of a page basis. However, as described below, it is generally possible to facilitate clustering. For this purpose, identifiers of a sphere and a point are made hierarchical as shown in FIG. 17.

Here, id is a unique serial number affixed to a sphere or a point. In the case of a sphere, the number is assumed to be assigned in the order of generation from 1. Therefore, a root sphere id is 1. Similarly, in the case of a point, the number is assumed to be assigned in the order of generation from 1.

In addition, a level is a level of the point/sphere. parentId is an id of its parent sphere. Note that this is not a hierarchical identifier of the parent sphere. This is because id can be represented with a lesser amount. In the case of the root sphere, since there is no parent sphere, a value of parentId is assumed to be zero.

An index relation and a point relation are sorted based on a dictionary order of the hierarchical identifiers defined in this way. Since relations are usually stored on a secondary memory in the order of insertion, the relations can be clustered for each parent sphere by being sorted. Note that new records are inserted one after another in a database. Therefore, it is troublesome if restructuring by sort is performed every time a record is inserted. Therefore, it is possible to perform such restructuring periodically and during the night when a load on a computer is not high. On the other hand, in the case of a database system that supports a relation having a B-tree structure rather than a sequential relation, since the above-mentioned order is always kept by realizing a point relation and an index relation by the relation, restructuring becomes unnecessary.

6) Mixing of Points and Spheres

Since the present invention divides a space, some spheres include the small number of points. In an extreme case, the number is 1. This makes it meaningless to divide a sphere and a performance is deteriorated. In order to alleviate such a situation, it is possible to include a point record rather than spheres in a parent sphere. In this case, spheres and points are mixed in the parent sphere.

7) Hierarchized Storage Allowing Mixing of Points and Spheres

Methods of storing information in a flat structure and a hierarchized structure are described in 2) and 4). Here, it will be described how information is stored including mixing of points and spheres in 6). The point record and the point relation are completely the same as those in 2) and 4).

An index relation is as described below.

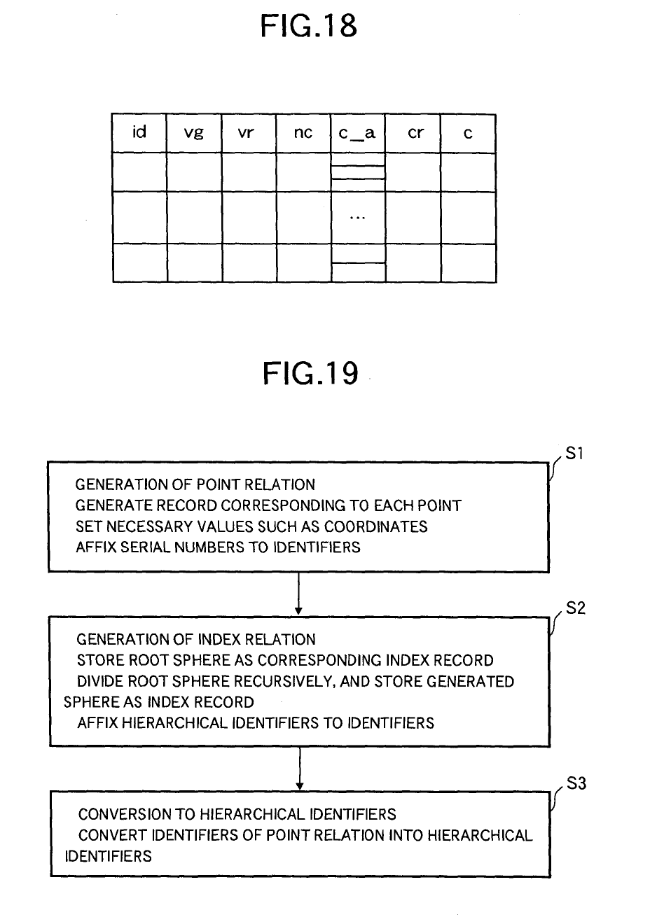

Information on a sphere is also stored in the index relation as shown in FIG. 18. Information on one sphere is stored in one index record. Association between information to be stored and a field name is as follows:

| Information to be stored | Field name | Remarks |
|---|---|---|
| Identifier | id | Index |
| Center of gravity of | vg | |
| a substantial sphere | | |
| Radius of a substantial | vr | |
| sphere | | |
| Number of child spheres | ns | |
| included in a sphere | | |
| Array for spheres | s_a | Array |
| included in a sphere | | |
| Number of points included in | np | |
| a sphere | | |
| Array for points included in | p_a | Array |
| a sphere | | |
| Radius of a child sphere | cr | |
| (zero in the case of | | |
| a leaf sphere) | | |
| [Center] | c | |

Simply speaking, this is a structure having an array of points in the case of the leaf sphere and an array of spheres in the case of the node sphere in 4). A field ns represents the number of child spheres and a field np represents the number of points included in the sphere. Structures of elements of the arrays are the same as those described before. That is, the same array of points as that shown in FIG. 9 and the same array of child spheres as that shown in FIG. 15 are used. If the method described in 3.4) is adopted, it is unnecessary to give a center. Whether the sphere is the leaf sphere is judged depending on a value of the field ns being zero or not. 8) Addition and Deletion of a Point

Here, further addition and deletion of a point after an index is once generated will be described. A distance to the center of gravity of a set of points or to a point most distant from the center of gravity varies in accordance with addition and deletion of a point. Child spheres cannot be arranged regularly if a center of a substantial sphere and a substantial radius are changed in accordance with the addition and deletion. Thus, a position of the center of the substantial sphere is not changed after the time of division of a sphere even if a point is added or deleted. A radius at the time of division is specifically referred to as a substantial radius at the time of division, and a dynamically changing radius is referred to as a dynamic substantial radius or simply as a substantial radius. The substantial radius at the time of division is used if it is necessary to generate a new sphere in accordance with addition of a point, and the dynamic substantial radius is used at the time of retrieval. Therefore, although the substantial radius has been described as stored in the above description of storage, it becomes further necessary to store the substantial radius at the time of division.

9) Entire Flow at the Time of Index Generation

The storage structure of a relation has been described. Here, it will be described how an index is generated as a whole using the storage structure. FIG. 19 shows an entire flow diagram of operations of a multidimensional index generation apparatus.

First, a relation is generated (S1). A tuple is generated to set a coordinate value and an identifier for each point. As the identifier, serial numbers 1, 2, . . . nd so on in the order of generation are used.

Next, an index relation will be generated (S2). First, an index record corresponding to a root sphere including all points is generated. Next, the root sphere is divided recursively and an index record corresponding to the generated sphere is generated. An identifier and a necessary value are set in the index record. A hierarchical identifier is used as the identifier.

Lastly, an identifier of a point relation is converted into a hierarchical identifier based on a serial number (S3). Note that processing in accordance with addition of a point is processing according to this generation. In deletion of a point, a corresponding point record is deleted and, at the same time, information on a sphere in which the point is included is updated. If no point is included in a sphere any more, the sphere is deleted and, at the same time, information on its parent sphere is updated.

II. Approximation

The preparation of a multidimensional index by spheres has been described. More speed-up can be realized by further adding filtering by approximation to this method. This method of approximation will be described first.

1) Method of Approximation

1.1) Approximation of Points in a Sphere

A situation in which points are distributed in a sphere with a certain point as a center will be hereinafter considered. The center may be an arbitrary point but is assumed to coincide with an origin of a multidimensional space in order to simplify descriptions. This sphere is referred to as an object sphere in that object points are distributed in its inside. A radius of the object sphere may be arbitrary but is assumed to be 1 without losing generality in order to simplify descriptions as well. A sphere with a radius 1 is also referred to as a unit sphere.

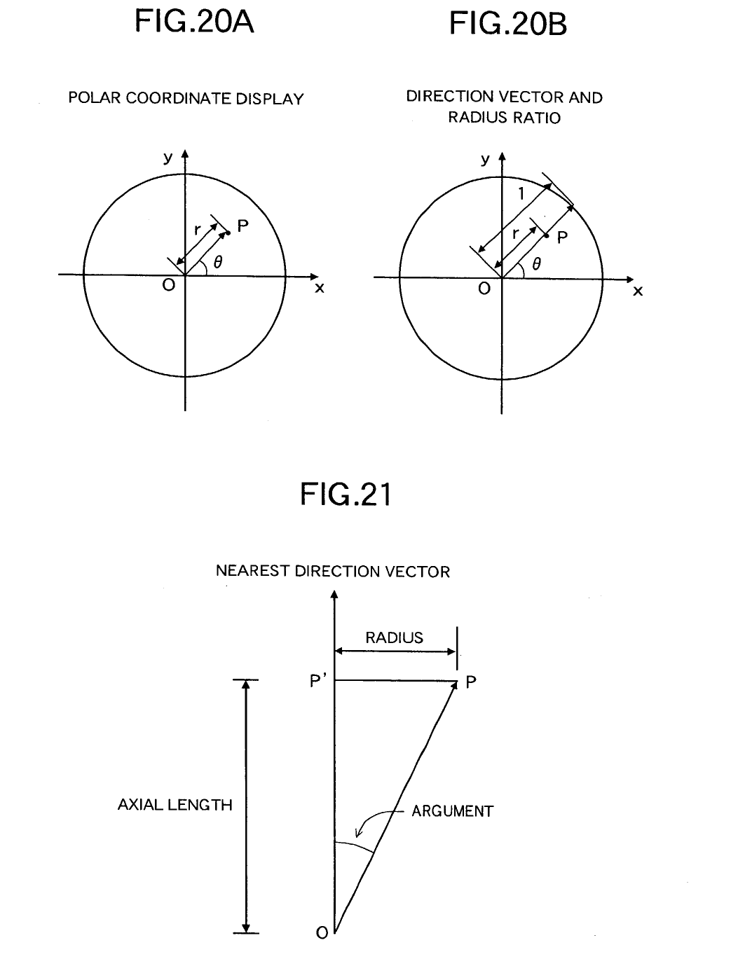

For simplicity, the method of approximation will be described in the two dimension. As a method of representing a point in a circle, polar coordinates shown in FIG. 20A are possible. That is, a point can be represented by a pair of an angle θ and a distance r from the origin. If θ and r are approximated to be represented by a bits and b bits, respectively, the point can be represented by a+b bits as a whole. This representation proves serviceable in the approximation by rectangular coordinates. This idea is extended to the n dimension. An angle can be considered to represent a direction. As shown in FIG. 20B, the direction can also be considered to be represented by a vector OQ when a point where extended OP intersects a circumference is assumed to be Q. A vector with a length 1 representing this direction is referred to as a direction vector. Then, a point in the sphere can be represented by a pair of two amounts of (direction vector, distance from the origin).

Although the limitless number of direction vectors exist, direction vectors that can be represented on a computer are limited. Now, the number of vectors to be used is assumed to be m, and a set of these direction vectors is referred to as a direction vector set and represented by D. If the i-th direction vector is represented by d(i), the following expression is obtained:

D={d(1), d(2), . . . , d(m)}.

A most natural method of approximating a point in a sphere using a direction vector is as described below. As shown in FIG. 21, a direction vector having a smallest angle with respect to the vector OP among D is found (an angle between two vectors is referred to as an argument). This vector is referred to as a nearest direction vector corresponding to the point P. When a normal is drawn from the point P to the nearest direction vector and a foot of the normal is assumed to be P′, P is approximated with P′ as a basis. P′ means a point closest to P among the points on the direction vector of the set of direction vectors. “Most natural” in the above description means this. The vector OP′is referred to as an axial vector and its length is referred to as an axial length. In addition, a distance from P to the direction vector, that is, a length of a line PP′ is referred to as a radius of P.

As a method of approximating an object point based on the above description, methods described below are adopted.

(a) Approximation by a Sphere

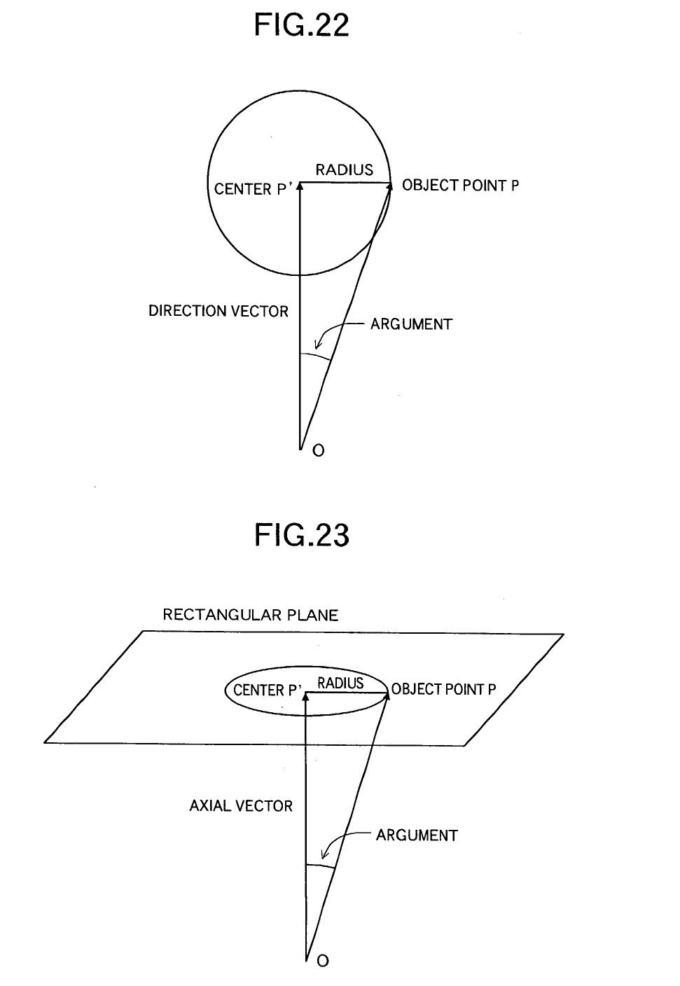

As shown in FIG. 22, a sphere with P′ as its center and having the point P on its surface is considered. A radius of this sphere is a radius of the object point P. Then, the point P exists on this spherical surface. Since the center is decided by (direction vector, axial length), the sphere can be represented by (direction vector, axial length, radius), which becomes an approximate representation of the object point P.

(b) Approximation by a Circumference

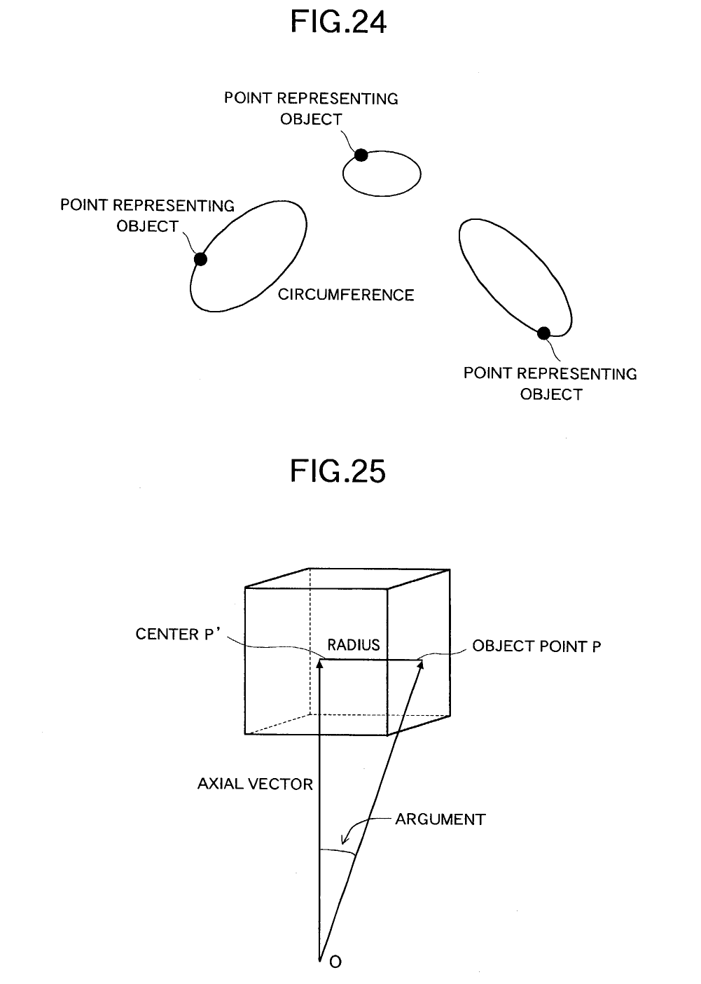

As shown in FIG. 23, a plane that passes through the center P′ and is vertical to an axial vector is considered. This plane is referred to as a rectangular plane or a circumference plane (of the axial vector). A circumference with P′ as a center and a radius of P as a radius on this plane is considered. Then, the point P exists on this circumference. Therefore, as in (a), the point P can be represented by a direction vector, an axial length and a radius. Although FIG. 21 is the three dimensional, in general, this circumference becomes a sphere of the n+1 dimension in the n dimension. Note that, although a term “circumference” is used also in this case, it is actually an n+1-dimensional sphere. Although the rectangular plane is referred to as a plane, it is an n+1-dimensional space. By this approximation, as a whole, the circumference corresponds to each point as shown in FIG. 24. This is the same for (a), (c) and (d).

(c) Approximation by a Cube

As shown in FIG. 25, a cube with P′ as its center and having a point P on its surface is considered. A length of one side of this cube is twice as long as a radius of an object point P. Thus, the point P can be approximated and represented by a direction vector, an axial length and a radius.

(d) Approximation by a Regular Quadrangle

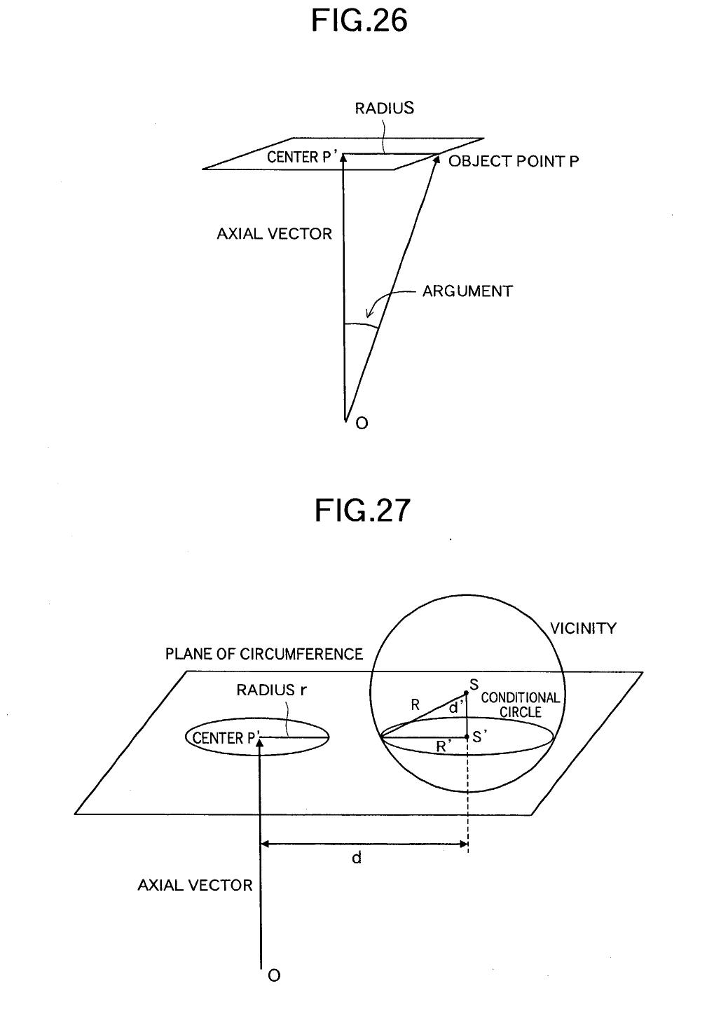

As shown in FIG. 26, a regular quadrangle with P′ as its center and having a point P on its side is considered. A length of one side of this regular quadrangle is twice as large as a radius of an object point P as in (c). Then, the object point can be approximated and represented by a direction vector, an axial length and a radius. Note that, although FIG. 26 is shown in the three dimension as in (b), in general, this regular quadrangle is an n+1-dimensional cube in the n dimension. The term “regular quadrangle” is used in this case, it is actually the n+1-dimensional cube.

Further, when (a) and (b) are compared, both of them approximate a point with the same approximate information. However, apparently, (b) realizes better approximation. This is because one dimension is reduced. Therefore, only (b) will be hereinafter described. This is true for (c) and (d). Therefore, only (d) will be described in this case as well. Note that the approximate information can be represented as a set of three values as shown below in both the cases of (b) and (d).

|direction vector identifier|axial length|radius|

The direction vector identifier is a number affixed to the direction vector. When the number of direction vectors is m, the direction vectors can be represented with ceiling (Ig(m)) bits if it is represented well. Here, ceiling (x) means a minimum integer of x or more and Ig(x) means a logarithm with 2 as a base. This approximate information is stored in an index record separate from a point record. Then, it is used for filtering for not allowing access to the point record as much as possible. Next, this filtering will be described.

1.2) Filtering

(a) Filtering by a Circumference

Next, a method of filtering using approximate information of a circumference will be described. It is judged whether the circumference intersects vicinity based on this approximate information. If the circumference does not intersect the vicinity, since points corresponding to the circumference are not included in the vicinity, it becomes unnecessary to access the point record to judge whether or not the points are included in the vicinity. Consequently, filtering can be performed. If the circumference intersects the vicinity, it is likely that the points are included in the vicinity. Thus, in this case, access is made to the point record to judge the point record in more detail.

The judgment on whether or not a circumference intersects vicinity can be performed as described below.

<1> Judgment on Whether a Plane of a Circumference and Vicinity Intersect

As shown in FIG. 27, a normal is drawn from the vicinity to the plane of the circumference. A foot of the normal is assumed to be S′. A distance from a center of the vicinity to S′ is assumed to be d′. If d′ is larger than a radius R of the vicinity, the vicinity does not intersect the plane of the circumference. Therefore, the vicinity does not intersect the circumference either. FIG. 27 shows a case in which the vicinity does not intersect the plane of the circumference.

<2> A Case in Which the Vicinity and the Plane of the Circumference Intersect

A circle formed by the vicinity and the plane of the circumference intersecting is decided. This circle is referred to as a conditional circle. Although the conditional circle is very similar to the circumference, it should be noted that points inside the circle are also included. The center is S′ found in 1). A radius R′ is found by sqrt(RA2-d A2). sqrt(x) means a square root of x.

<3> Judgment on Whether the Conditional Circle and the Circumference Intersect

A distance between the center P′ of the circumference and the center s' of the conditional circle is assumed to be d. If r+R′ <d, the conditional circle and the circumference do not intersect. In this case, the circumference is outside the conditional circle. In the case of d+R′<r, the conditional circle and the circumference do not intersect either. In this case, the conditional circle is entirely contained in the circumference. In cases other than the above-mentioned two conditions, the circle in the vicinity and the circumference intersect. A condition for the conditional circle and the circumference to intersect is that these two conditions are not established. This is represented as follows:

r−R′<=d<=r+R′.

(b) Filtering by a Square Circumference

Filtering by a square circumference is basically the same as the filtering by a circumference substantially. However, it is different from the filtering by a circumference in that whether a square circumference and a circle intersect is judged.

1.3) Method of Deciding a Set of Direction Vectors and a Nearest Direction Vector

Among approximate information on a circumference and a square circumference, an axial length and a radius can be represented by a floating point number (four bytes). It is also possible to further quantize and represent them by an integer value of one or two bytes or by a few bits. Among approximate information, what is most difficult to decide is a nearest direction vector. That is, it is issues of how to decide a set of direction vectors and how to find a nearest direction vector out of them. These will be hereinafter described.

First, a method of deciding a set of direction vectors will be described. If the number of direction vectors m is reduced, a length of a direction vector identifier may be small. Therefore, approximate information may be little. Instead, since a direction becomes rough, a radius tends to be large and a filtering ratio is deteriorated. On the other hand, if the number of direction vectors is increased, a radius can be reduced and a filtering ratio is improved. However, approximate information increases. A method of deciding a set of direction vectors with an exact balance is required.

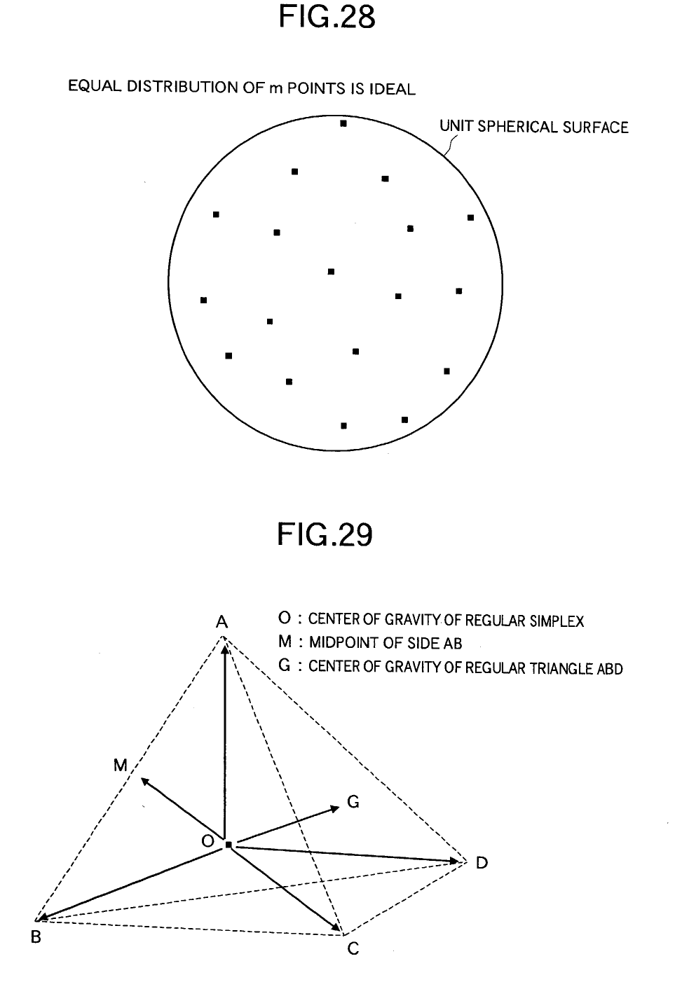

Ideally, in deciding m direction vectors, it is considered to be desirable to, assuming a spherical surface of a radius 1 (this is referred to as a unit spherical surface), arrange m points as equally as possible as shown in FIG. 28 on the spherical surface and set a vector from the center of the sphere to the point as a direction vector. This issue is also an issue of how a direction should be digitized on a computer. However, it is difficult to find this equal distribution. Thus, a method of deciding a set of direction vectors that makes the distribution as equal as possible will be considered.

Further, what is important when deciding a set of direction vectors is that the direction vector is found by calculation from a direction vector identifier. For example, it is possible to find coordinates of a direction vector using a dummy random number and store the coordinates on a secondary memory together with the direction vector identifier in an attempt to find an equal direction vector. However, this is meaningless because an objective is approximation to the end and, if coordinates are stored, an amount of information equivalent to that of information on an original point is required. In addition, it is also a problem of this method that, since a nearest direction vector is found, necessity for accessing information on a large number of direction vectors occurs.

When a set of direction vectors is decided, the next problem is how to find a nearest direction vector out of the set. Several methods will be hereinafter shown concerning ways of deciding a set of direction vectors and finding a nearest direction vector.

(a) Simple Method According to Rectangular Coordinate

A vector np having a length of 1 that is an extended length of an object vector will be considered. Extending a length of a certain vector to be 1 in this way is referred to as normalizing the vector. Each coordinate of np is assumed to be x(1), x(2), . . . , x(n). Now, coordinates of one dimension is represented by k bits and each coordinate is to be quantized according to the following expression:

b(i)=floor((2\hat{ }k−1)*x(i)).

floor(x) means a maximum integer equal to or smaller than x.

axis=(b(1), b(2), . . . , b(n))

will be considered. A vector that is found by normalizing this vector is assumed to be a direction vector. An identifier of this direction vector is represented by k*n bits. It is easy to calculate the direction vector from this identifier due to the above reason. It is also possible to represent axis as an integer value as follows (however, the integer value is likely to largely exceed normal 32 bits, in which case an integer is represented by a long bit string):

k\hat{ }(n+1)+b(2)k\hat{ }(n−2)+ . . . +b(n).

In this way, it is possible to represent an integer by the number of bits equal to or smaller than k\hat{ }n. An advantage of this method is that it is easy to understand because rectangular coordinates are used. However, this is basically the same idea as the case in which the conventional method was described before, and approximate representation becomes redundant.

(b) Method Using a Regular Simplex

A regular simplex will be considered. The center of gravity of this regular simplex is matched with an origin of an object sphere. A length to each vertex of the regular simplex from the center of gravity is assumed to be 1. Therefore, this regular simplex internally contacts the object sphere (because a radius of the object sphere is assumed to be 1 without losing generality). A vector from this center of gravity to each vertex is referred to as a vertex vector, and this vertex vector is assumed to be a direction vector. Therefore, first, n+1 direction vectors equivalent to the number of vertexes are created. These vectors are assumed to be as follows:

v(1), v(2), . . . , v(n+1).

In addition, a set of these vertex vectors is assumed to be D(1).

Since all distances between vertexes are the same, these vectors are considered to face directions equal angle apart from each other. FIG. 29 shows the case of the three dimension. Therefore, the regular simplex is a regular tetrahedron. Vectors OA, OB, OC and OD from an origin O to vertexes are vertex vectors. If the above-mentioned method is used, this is represented as follows:

v(1)=OA, v(2)=OB, v(3) OC, v(4)=OD.

If it is desired to further increase the number of directions, a vector that is found by normalizing a vector from the center of gravity to a midpoint of a side can be selected. If two vertex vectors are assumed to be v(i) and v(j), this vector can be easily calculated as follows:

n(v(i)+v(j))/2)).

When x is assumed to be a vector, n(x) means a normalized vector of x. In addition, these vectors are separate vectors from the vertex vectors. In FIG. 29, n (vector OM) is one of such vectors, which is represented as follows:

OM=(OA+OB)/2=(v(1)+v(2))/2.

The number of these vectors is represented as follows:

C(n+1, 2)=(n+1)n/2!=(n+1)n/2.

Here, C(x, y) means the number of combinations when y items are taken out from x items. A set of these vectors is assumed to be D(2). Although these vectors and the vertex vectors are not considered to face directions equal angle apart from each other, the vectors are apart from each other by a certain angle.

Moreover, when three vectors v(i), v(j) and v(k) are considered, vertexes of them form a regular triangle. When a vector found by normalizing a vector from the center of gravity of a regular simplex to the center of gravity of this regular triangle is considered, this also becomes a separate direction vector. In FIG. 29, n (vector OG) corresponds to this vector. A vector to the center of gravity of three vectors can be calculated by the following as in the case of a side:

(v(i)+v(j)+v(k))/3.

The vector OG of FIG. 29 is represented by an expression as follows:

OG=(OA+OC+OD)/3=(v(1)+v(3)+v(4))/3.

A vector found by normalizing a vector to the center of gravity of these is separated from a vector found by normalizing a vertex vector or a vector to a midpoint of a side. The number of these vectors is represented as follows:

C(n+1, 3)=(n+1)n(n+1)/3!=(n+1)n(n+1)/6.

A set of these vectors is assumed to be D(3).

Similarly, when k (k<=n) vertex vectors are generally considered and a vector found by normalizing the following vector is considered:

(v(i1)+v(i2)+v(i3)+. . . v(ik))/k,

this also becomes a new direction vector. The number of these vectors is represented as follows:

C(n+1, k)=(n+1)n(n+1) . . . (n−k+2)/k!

A set of vectors found by normalizing a vector to the center of gravity of these k vertex vectors is assumed to be D(k).

After all, the following set of vectors is generated using maximum k (1<=k<=n) vertex vectors:

n((v(i(1))+v(i(2))+ . . . v(i(j)))/j)

1<=j<=k

1<=i(1)<=i(2)<=. . . <=i(j)<=n+1. [1]

and these vectors can be used as direction vectors. The total number is as follows:

C(n, 1)+C(n+1, 2)+ . . . +(n+1, k).

In particular, in the case of k=n, if a maximal set of direction vectors is considered, the number of the vectors is represented as follows:

2\hat{ }(n+1)−2.

When a set of these vectors is assumed to be SD(k), the following expression is obtained:

SD(k)=D(1)+D(2)+ . . . +D(k).

+ represents a direct sum of the set. The direct sum is a sum set and means that there is no common part.

These vectors with numbers added in order are used as direction vector identifiers. In this case, it is also important as described above that vectors can be calculated from the numbers. The numbers are affixed in the order of one generated from one vertex vector, one generated from two vertex vectors, . . . , one generated from k vertex vectors. For one generated from j vertex vectors, considering that the following is a number of j digits in the inequality [1]:

i(1), i(2), . . . , i(j),

the numbers are affixed in the order of smallness of this number. Therefore, the number i of k is affixed to the vertex vector v(i). The numbers are affixed to the vectors of D(2) in the order from |D(1)|+1, and the numbers are generally affixed to the vectors of D(j) in the order from the following:

|D(1)1+|D(2)|+ . . . +|D(j−1)|+1.

Here, when X is assumed to be a set, |X| means the number of elements included in the set.

Therefore, it can be easily calculated how many vertex vectors are used to generate a set. This is because, when a number affixed to a direction vector is assumed to be id, if id is as follows,

|D(1)+D(2) . . . +D(j−1)|<id<=|D(1)+D(2) . . . +D(j)|,

a vector corresponding to id is one found by adding up j vertex vectors. What matters is which vectors are added up to create a set.

When it is assumed as follows,

h=id−|D(1)+D(2) . . . +D(j−1)|,

this corresponds to an h-th vector among D(j). Therefore, as described above, when the following is considered to be a number of i digits:

i(1), i(2), . . . , i(j),

if an h-th one from the smallest one is found, a vertex vector is seen from i(1), i(2), . . ., i(j).

Note that it is meaningless to consider the vector that adds up all vertex vectors to find the center of gravity:

v(1)+(v2)+ . . . +v(n+1)/(n+1).

This is because, if n+1 vertex vectors are added up, a zero vector (vector with a length of zero) is obtained, which cannot be used as a direction vector. This is the reason for k<=n. It can be easily calculated to select a nearest direction vector of an object vector out of SD(k). It is assumed that vertex vectors are arranged as follows from one with a smallest argument with respect to the object vector:

v(i(1)), v(i(2)), . . . , v(i(k)).

In this case, it is assumed that the following expressions are obtained:

g(1)=n(v(i(1)))

g(2)=n((v(i(1))+v(i(2))/2)

g(k)=n((v(i(1))+v(i(2))+ . . . +v(i(k)))/k).

In addition, in this case, g(i) has the smallest argument with respect to the object vector among D(i).

Therefore, a direction vector having a smallest argument with respect to the object vector, that is, a nearest direction vector exists in the following:

g(1), g(2), . . . , g(n).

When an argument of each of the above is determined, a vector having a smallest argument among them can be found as the nearest direction vector.

(c) Method According to a Center of Gravity String of a Regular Simplex

As in the case of (b), k (k<=n) vectors are selected out of vertex vectors of a regular simplex in the order of smallness of an argument with respect to an object vector as follows:

v(i(1)), v(i(2)), . . . ., v(i(k)) [2]

Then, as in (b), g(1), g(2), . . . , g(k) are found as follows:

g(1)=v(i(1))

g(2)=(v(i(1))+v(i(2))/2

. . .

g(k)=(v(i(1))+v(i(2))+ . . . +v(i(k)))/k.

However, unlike the case of (b), g(i) is not normalized but represents centers of gravity, respectively. However, a length of a vector has no relation with an argument. Therefore, as in (b), g(i) has the same direction as a vector having a smallest argument with respect to an object vector among D(i). However, it cannot be seen which of g(1), g(2), . . . , g(k) has the smallest vector with respect to the object vector only from the information of [2].

Further, it is likely that a vector that is found by, considering a point in a k-dimensional simplex formed by g(1), g(2), . . . , g(k), normalizing a vector from the origin to the point has a smaller argument with respect to the object vector than g(1), g(2), . . . , g(k). Thus, a vector found by normalizing a vector to the centers of gravity of g(1), g(2), . . . , g(k), that is,

g=n((g(1)+g(2)+ . . . +g(k))/k)

is found, and this is set as a direction vector. An identifier of this direction vector can be found by arranging numbers of the vertex vectors as follows:

i(1), i(2), . . . , i(k) [3]

Experimentally, it is known that on average a vector closer to the object vector can be found than the method of (b).

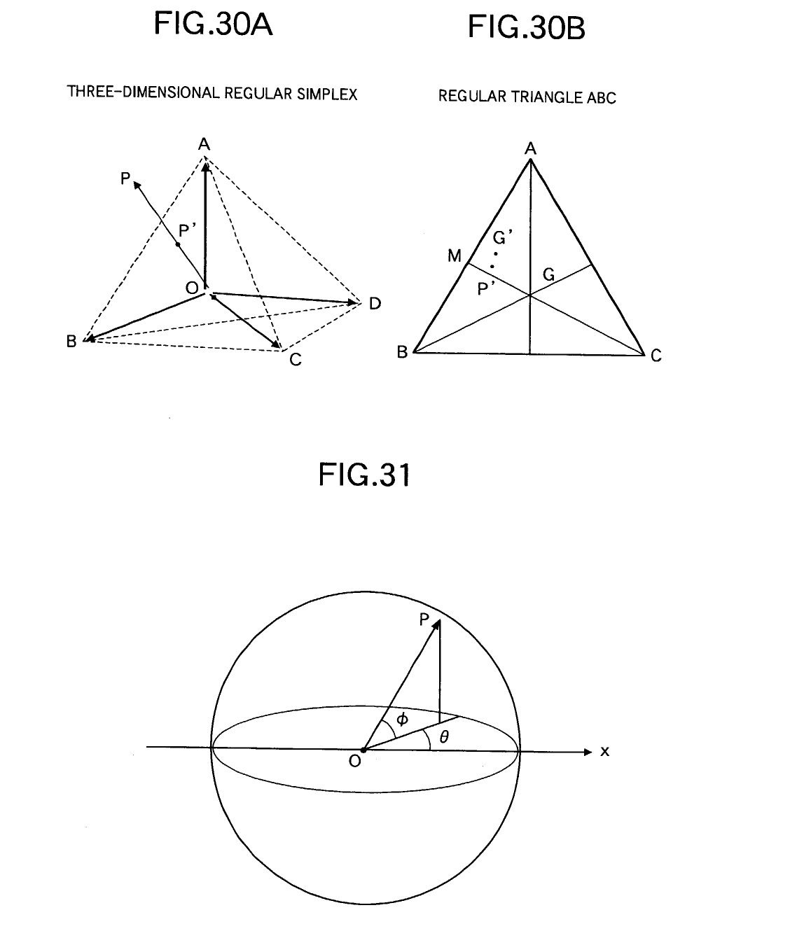

FIGS. 30A and 30B illustrate the case of the three dimension. It is assumed that an object point P is approximated. As shown in FIG. 30A, it is assumed that the object point P intersects a regular triangle ABC. The intersection is assumed to be P′ (if the object point P and the regular triangle ABC do not intersect, a vector OP is extended to find an intersection with the extended line). FIG. 30B shows an extracted part of this regular triangle ABC. Vectors OA, OB and OC are vertex vectors v(1), v(2) and v(3). As shown in FIG. 30A, it is assumed that, as an argument formed with respect to the object vector OP, OA=v(1) is the smallest, then, OB=v(2), and OC=v(3) is the largest. g(1)=v(1). When it is assumed that a midpoint of AB is M, g(2) is a vector OM. When it is assumed that the center of gravity of the regular triangle ABC is G, g(3) is a vector OG.

When it is assumed that the center of gravity of a regular triangle AMG is G.

g(g(1)+g(2)+g(3))

is OG′. In the example of FIG. 30B, G′ is certainly closer to a point P′ than points A, M and G, and an argument of vectors OG′ and OP′ is smaller than arguments that the vector OP′ forms with respect to the vector OA, the vector OM and the vector OG, respectively. That is, it is better to set a vector found by normalizing the vector OG′ as a direction vector than setting a vector found by normalizing the vectors OA, OM and OG as a direction vector.

(d) Method by Finding a Center of Gravity String of a Regular Simplex and a Midpoint Thereof

Based on g(1), g(2), . . . , g(k) found in (b), it is assumed that a vector having a smallest argument with respect to the object vector among them is g(i). This method is different from (c) in that g(i) is normalized. In this case, when it is assumed that a vector from the origin O to a midpoint of g(j) (j≠i) and g(i) is m(j), that is,

m(j)=(g(i)+g(j))/2,

it can be said that an argument of m(j) and the object vector is smaller than an argument of g(j) and the object vector. This m(j) is replaced by the normalized vector g(j).

A group of vectors g(1), g(2), . . . , g(k) created anew is closer to the object vector. In general, this operation is repeated t times and, thereafter, the center of gravity g of g(1), g(2), . . . , g(k) is found and a vector found by normalizing it is set as a direction vector. Further, increasing t does not always make the vectors closer to the object vector. This is because, when this process is continued, it becomes likely that a vector closest to the object vector exists outside a simplex formed by g(1), g(2), . . . , g(k).

The vector found by this method is represented by the following set indicating which g(i) is close to the object vector in [3] and thereafter as in (c):

j1, j2, . . . , jt [4]

That is, the vector is represented by the following:

i(1), i(2), . . . i(k), j1, j2, . . . , jt.

In (d), a vector closer to the object vector than in (c) can be found. However, a direction vector identifier is longer by the amount of [4]. In addition, if a direction vector closest to the object vector is found in the middle among the number of times t, the operation is not continued up to jt but terminated in the middle.

(e) Method According to an Angle

This method represents a direction vector by an angle.

In the two dimension, a point on a circumference can be represented by an angle θ(0<=θ<=2π) shown in FIG. 20A. A point on a three-dimensional spherical surface can be represented by a set of (θ, φ)−π/2<=φ<=π/2) as shown in FIG. 31. Since a point on the spherical surface corresponds to a direction vector, the direction vector can be represented by an angle in this way.

In general, a point on a spherical surface can be represented by the following in the n-dimensional space:

(θ, φ(3), φ(4), . . . , φ(n))

0<=θ<=2π

−π/2<=φ(i)<=π/2 (3<=i<=n).

φ(i) represents an angle in the i dimension. There is no waste such as rectangular coordinates in this representation either. When a bits are assigned to θ and b bits are assigned to each φ (i) to quantize an angle, a direction vector can be represented by a+(n−2) b bits.

An easiest method of quantization is to, assuming that

A=π/(2\hat{ }a)

B=π/(2\hat{ }b),

associate j satisfying the following expression with θ:

jA<=θ<(j+1)A (0<=j<2\hat{ }a)

and k(i) satisfying the following expression with φ(i):

k(i)A<=φ(i)+π/2<(k(i)+1)A (0<=k(i)<2\hat{ }b),

and represent the direction vector as follows:

c=(j,k(3), k(4), . . . , k(n)) [5]

It is assumed that an area corresponding to c on a spherical surface is represented by R(c).

All points in R(c) are represented by c. Therefore, a point corresponding to a center of R(c) is associated with the direction vector, whereby 2\hat{ }(a +(n−2)b) direction vectors can be represented by c. However, what matters here is that area occupied by R(c) is not the same for all the points.

Thus, next, it is considered to make all the areas occupied by R(c) the same.

It is assumed that

C=½\hat{ }(b−1),

and k(i) satisfying the following expression is associated with φ(i):

k(i)C−1<=sin (φ(i))<(k(i)+1)C−1 (0<=k(i)<2\hat{ }b).

sin (x) is a sine function. In this case, when a direction vector is represented by [5], R(c) is the same for all the points. Although it cannot be said that directions of direction vectors according to this method are not the same angle apart from each other, the method at least has a preferable nature in that all areas of parts on a spherical surface corresponding to the direction vectors are the same.

(f) Recursive Dimension Division and Adaptive Bit Assignment

For simplicity, descriptions will be made assuming that the dimension is 2\hat{ }n.

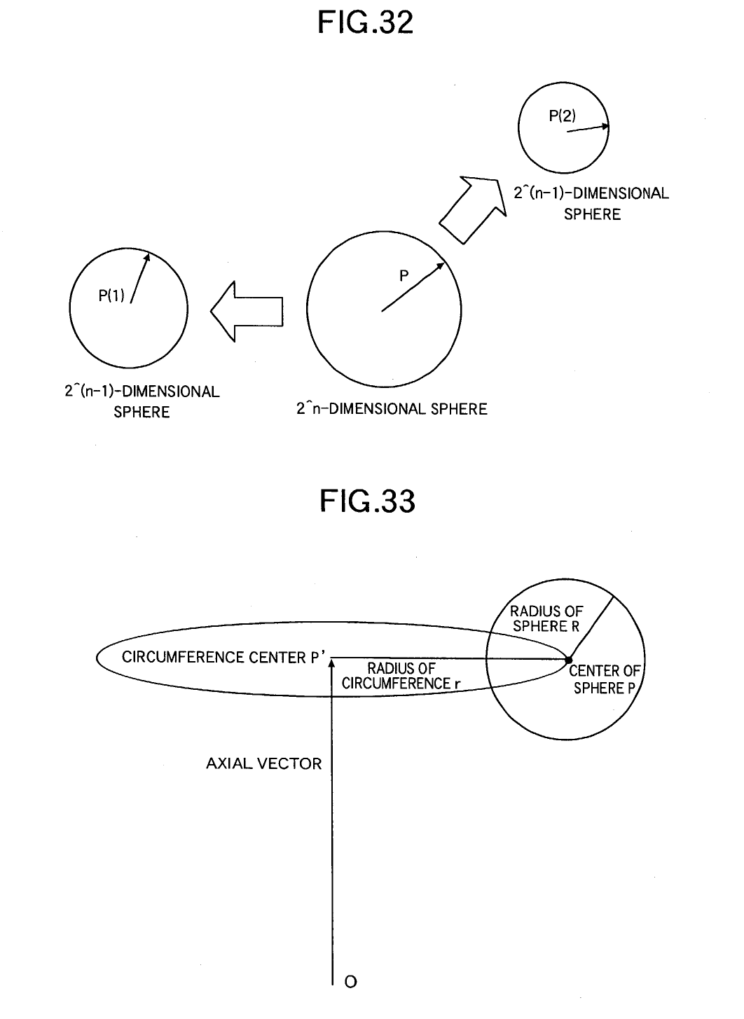

In this method, an object vector intended to be approximated is divided into two dimensions recursively. A vector to be an object of this division is assumed to be p. It is assumed that, at first, p is a vector found by normalizing the object vector. FIG. 32 shows how this division is performed.

When it is assumed as follows:

p=(x(1),x(2), . . . ,x(2\hat{ }n)),

p(1)=(x(1),x(2), . . . ,x(2′(n+1)),0, . . . 0)

p(2)=(0, 0, . . . , 0, x(2\hat{ }(n+1)+1), . . . ,x(2\hat{ }n),

p=p(1)+p(2).

Now, excluding parts where coordinates are zero, p(1) and p(2) are defined as follows again:

p(1)=(x(1),x(2), . . . , x(2\hat{ }n)),

p(2)=x(2\hat{ }(n+1)+1), . . . , x(2\hat{ }n).

Then, an arithmetic operation of (+) is introduced. This operator is for generating an i+j-dimensional vector

(a(1), a(2), . . . , a(i), b(1), b(2), . . . , b(j))

from an i-dimensional vector

a=(a(1), a(2), . . . , a(i))

and a j-dimensional vector

b=(b(1), b(2), . . . , b(j)).

If this operator is used, the vector p is represented as follows:

p=p(1)+p(2).

If this operation is compared to a character string, it corresponds to connection. An end point of p exists on a 2\hat{ }n-dimensional sphere with a radius |p| (|x| means a length of a vector x). Similarly, end points of p(1) and p(2) exist on a 2\hat{ }(n+1)-dimensional sphere with a radius |p(1)| and |p(2)|, respectively.

Here, an identifier of p is represented by |γ|identifier of p(1)|identifier of p(2)|.

γ is what is called a length ratio of p(1) with respect to p and is represented as follows:

γ=|p(1)|/|p|.

That is, the following expression is established:

|p(1)|=γ|P|.

If |p| and γ are known, |p(1)| can be calculated. Similarly, since there is the following relationship:

|p|\hat{ }2=|p(1)|\hat{ }2+|p(2)|\hat{ }2,

the following expression is established:

|p(2)|=sqrt(1−γ\hat{ }2)|p|.

At first, since |p|=1, |p(1)|and |p(2)| can be calculated from γ.

Here, what matters is how many bits are assigned to them, respectively.

Now, it is assumed that k bits are assigned to γ first. In addition, the number of bits assigned to the identifier of p(1) and the identifier of p(2) is assumed to be as follows:

number of bits assigned to p(1)=(2\hat{ }(n+1)−1)k(1),

number of bits assigned to p(2)=(2\hat{ }(n+1)−1)k(2),

where, k(1)+k(2)=2*k.

That is, this means that, while 2(n−1)k bits are assigned to the entire p(1) and p(2), the bits are allocated with a ratio of k(1):k(2). Here, when it is assumed that k(1)′ and k(2)′ are values with which the following expression is established:

2\hat{ }((2\hat{ }(n−1)−1)k(1)′):2\hat{ }((2\hat{ }(n−1)−1)k(2)′)=S(2\hat{ }(n+1),|p(1)|:S(2\hat{ }(n+1),|p(2)|,

where a function S(m, r) is assumed to be a surface area of an m-dimensional sphere with a radius r,

k(1)′ and k(2)′ are decided such that

if k(1)′≧k(2)′,

k(1)=ceiling(k(1)′) and

k(2)=floor(k(2)′), and

if k(1)′<k(2)′,

k(1)=floor(k(1)′) and

k(2)=ceiling(k(2)′).

Here, ceiling(x) means a minimum integer equal to or larger than x and floor(x) means a maximum integer equal to or smaller than x.

The above description means that k(1) and k(2) are decided such that a ratio of numbers in the case in which they are represented by respective identifiers become nearly equal to a ratio of surface areas of respective spheres. Further, the surface area is represented as follows:

S(m,r)=m(π/2)\hat{ }(m/2)*r\hat{ }(m⁻¹)/Γ(n/2+1).

Here, a function Γ(s) is a γ function. Note that it is easily performed to find k(1) and k(2).

Further, the above operations are applied to p(1) and p(2) recursively, whereby an identifier of p can be found. Note that k(1) bits are assigned toy of the identifier of p(1) and k(2) bits are assigned to γ of the identifier of p(2).

When the processing proceeds recursively, p(1) and p(2) turn into the two dimension finally. In this case, an angle 0 to the x axis in FIG. 20A is quantized. That is, assuming that k bits are assigned to p(1) and p(2), respectively, θ is approximated by an integer i satisfying the following:

(2π/2\hat{ }k)*i≦θ<(2π/2\hat{ }k)*(i+1)

0≦i<2\hat{ }k.

When the angle is returned to an original angle from i, an average is taken as follows:

(2π/2\hat{ }k)*(i+1/2).

Note that it is also possible to approximate the two-dimensional p(1) and p(2) by rectangular coordinates.

The case in which the dimension is 2\hat{ }n has been described. In a general case, a method as described below is adopted.

<1> In the Case in Which p is the 2n Dimension

p is divided into two n-dimensional vectors p1 and p2. Thereafter, the same processing as described above is performed.

<2> The Case in Which p is (2n+1) dimension

Points different from the above description will be described.

p is divided into two vectors, an n+1-dimensional vector p1 and an n-dimensional vector p2.

The number of bits assigned to p1 and p2 is as follows:

number of bits assigned to p(1)=n*k(1)

number of bits assigned to p(2)=(n+1)*k(2),

and k(1) and k(2) are found in the same manner as described above from the following expression:

2\hat{ }((n+1)k(1)′):2\hat{ }(n*k(2)′)=S(n+1, |p(1)|):S(n, |p(2)|).

In this case, calculation is not difficult.

Further, in general, p may become one dimension finally. In this case, there are only two directions of positive and negative, and an orientation can be represented by one bit. The entire number of bits is reduced by the number of one-dimensional parts created. Note that it is also possible to approximate a one-dimensional vector by rectangular coordinates.

Further, a method is also possible in which the number of bits assigned to γ and an angle is not the same but changed. However, since this method can be realized easily, its description is omitted. With this method, the number of bits is assigned adaptively in this way, and a vector can be approximated efficiently.

1.4) Approximation of a Sphere

(a) Method According to a Circumference

The method of approximating an object point has been described. However, in general, this method can approximate not only an object point but also a point. In particular, since a center of a sphere is also a point, it has a significant meaning to approximate a center. This is because, if a center can be approximated, the sphere itself can also be approximated by adding information on a radius to it. It is described above that the method of using a sphere as a cluster in a multidimensional index is used. With these methods, it is judged whether or not a sphere that is a cluster intersects vicinity and, if not intersecting, the number of times of access to a point vector or an index vector is reduced utilizing the advantage that the inside of the sphere may not be checked. If it is checked whether or not the sphere intersects the vicinity, an index record corresponding to the sphere is accessed to make the judgment from information on coordinates and a radius of its center. That is, a vector corresponding to the sphere must be accessed. However, when the sphere has been approximated, if it is found that the sphere does not intersect the vicinity from the approximate information without accessing an index record, it becomes unnecessary to access the index record.

This method will be hereinafter described.

It is considered to approximate a center of a sphere by a circumference. Then, the center of the sphere exists on the circumference. FIG. 33 shows the case of the three dimension. When it is assumed that a radius of a circumference is r and a radius of a sphere is R, the sphere exists within a sphere of a radius r+R with a center P′ of the circumference as a center. Filtering can be performed by judging whether or not this sphere and vicinity intersect. However, a method described next has a better filtering ratio than this method. When the sphere is turned along the circumference once, a trace that the sphere has passed forms a figure of a doughnut shape called a torus in the case of the three dimension. In general, in the n dimension, a trace becomes an area between large and small two spheres with the center of the circumference as a center. The small sphere contacts the vicinity and the large sphere includes the vicinity, and the spherical surface of the vicinity contacts the spherical surface of the large sphere from the inner side of the large sphere. This figure is also referred to as torus by analogy with the three dimension. Since the sphere exists in this torus, filtering of the sphere can be performed by judging whether or not this torus and the vicinity intersect.

(b) Method According to a Square Circumference

A method in the case of a square circumference is substantially the same as the case of the circumference. When a center of a sphere is moved along the circumference of the square circumference, a figure formed by a trace on which the sphere has passed becomes an area in which the sphere is likely to exist. However, this figure cannot be simply represented as a torus.

A method of approximating a center of a sphere with a figure slightly larger than this figure will be described. It is assumed that a radius of a sphere is R and a radius of a square circumference is r. Now, large and small two squares with a center of the square circumference as a center are considered. A larger radius is r+R and a smaller radius is max(r−R, 0). max(x, y) means a number of a larger one of x and y. An area between the large square circumference and a small square circumference is created on a square plane. This area is assumed to be A. When this area A is moved upward in a direction perpendicular to the plane by R, an area passing through A is created. The sphere exists in this area. Filtering is performed by judging whether or not this area intersects vicinity. Further, this area is larger than an area where the sphere is likely to exist actually.

Next, application of the above-mentioned approximation to the multidimensional index of the present invention will be described.

<1> Filtering of a Point Record

The methods described above are on the premise that, in order to judge whether or not a point included in an index record is included in vicinity, a point record included therein is accessed and checked. However, approximate information on the point record is given to an index record side and filtering is performed utilizing it, whereby the number of times of access to the point record can be reduced significantly.

<2> Filtering of an Index Record

Filtering of an index record is also possible in the same manner as the filtering of a point record. Approximate information on a child sphere is given to an index record of a parent sphere and filtering is performed using it. In this case, filtering by the above-described torus is used.

### 2) SPECIFIC EXAMPLES

Here, it will be described by several examples how similarity retrieval is specifically performed using the above-described methods.

(a) Method of Sequentially Scanning an Index

One index record is associated with each object point. When the number of object points is assumed to be m, m point records and index records are generated. Approximate information on an object point corresponding to this index record is held in the index record. Then, all index records are scanned in order and whether or not the corresponding object point is included in the vicinity is judged to perform filtering. Although the index record is stored in a secondary memory, it is also possible to cause it to reside on a main memory to realize speed-up if an amount of the index record is in the degree that allows it to be loaded on the main memory. This method is a method adopted in VA-file. However, VA-file is different in that approximation is performed using rectangular coordinates as described before.

(b) Method Applied to a Multidimensional Index Using a Sphere

As described before, several multidimensional indexes using a sphere have been proposed. More specifically, a multidimensional index is used in SS-tree and SR-tree, and in A-tree partially. SS-tree is a first method using a sphere and is known as a high speed method. Moreover, faster methods such as SR-tree and A-tree have been proposed which are improvements of SS-tree. In the multidimensional index using a sphere, an object point is divided by a plurality of spheres including the object point and it is judged whether or not the sphere intersects vicinity, whereby, if the sphere does not intersect the vicinity, reduction of the number of times of access to a point record is realized by utilizing the fact that it is unnecessary to check an object point included in the sphere. A set of direction vectors is decided with respect to an object point in the sphere considering that a center of the sphere is a center of the object sphere, whereby the method of the present invention can be applied. In addition, with respect to a sphere, approximate information on a sphere according to the present invention is also stored in an index record of a corresponding sphere and filtered at the time of retrieval, whereby it becomes possible to reduce the number of times of access to the index record corresponding to the sphere.

III. Similarity Retrieval (Retrieval)

A method of retrieval has been described briefly. Here, methods of range retrieval and ranking retrieval will be hereinafter described in more detail including processing of filtering according to approximation. Note that a result of retrieval is managed in the vicinity.

1) Range Retrieval

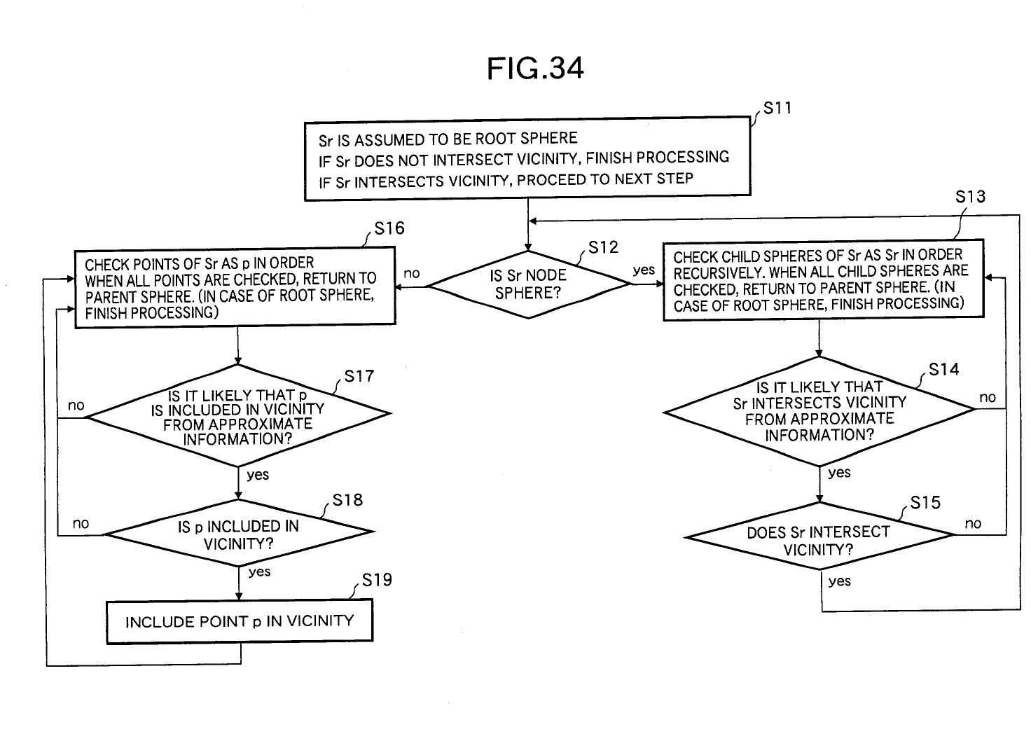

In the case of the range retrieval, a radius of the vicinity is fixed. Procedures of the retrieval will be hereinafter described with reference to FIG. 34. A sphere that is an object of retrieval during processing is represented as Sr. At first, Sr is a root sphere. In addition, a result of retrieval managed by the vicinity is empty at first.

(a) In the case in which the sphere Sr is a root sphere, it is checked whether or not it intersects the vicinity. If it intersects the vicinity, processing of (b) and subsequent processing are performed. If it does not intersect the vicinity, the retrieval is finished (S11).

(b) In the case in which the sphere Sr is a node sphere (S12, y), child spheres are checked in order. If a child sphere intersects the vicinity, processing of (b) and subsequent processing are recursively performed with the child sphere as the sphere Sr that is an object of retrieval. First, it is judged if it is likely that the child sphere intersects the vicinity by the method of torus described in the above-described “II. Approximation” from the approximate information. Only in the case in which there is the possibility, a corresponding index record is accessed and it is judged whether or not the child sphere actually intersects the vicinity. That is, child spheres of Sr are checked as Sr in order recursively and, when all the child spheres are checked, the processing returns to a parent sphere (the processing ends in the case of a root sphere) (S13). Next, it is judged whether or not it is likely that Sr intersects the vicinity from the approximate information. If it is likely (S14, y), it is judged whether or not Sr intersects the vicinity (S15). If the Sr intersects the vicinity, the child sphere is assumed to be the sphere Sr that is an object of retrieval. If it is unlikely that Sr intersects the vicinity from the approximate information (S14, n) or if Sr does not intersects the vicinity (S15, n), the processing returns to step S13 and the same processing is repeated.

(c) In the case in which the sphere Sr is a leaf sphere (S12, n), points included therein are checked in order and it is judged whether it is likely that a point is included in the vicinity from the approximate information. Only when it is likely, a point record corresponding to the point is accessed and it is judged whether or not the point is actually included in the vicinity. If it is included in the vicinity, the point is included in a vicinity sphere as a result of retrieval. That is, points of Sr are checked as p in order and, when all the points are checked, the processing returns to a parent sphere (the processing is finished in the case of a root sphere) (S16). Next, it is judged whether or not it is likely that p is included in the vicinity from the approximate information (S17). If it is likely (S17, y), it is judged whether or not p is included in the vicinity (S18). If it is included, the point p is included in the vicinity (S19). If it is unlikely that p is included in the vicinity from the approximate information (S17, n) or if p is not included in the vicinity (S18, n), the processing returns to step S16 and the same processing is repeated.

Further, in case of mixing points and spheres described in 6) of I, in a node sphere, the processing described in (c) is also applied to points included in the sphere.

2) Ranking Retrieval

It is known that a solution can be found only by tracing necessary minimum nodes in the ranking retrieval. Its basic method is described in [Katayama01]. A method using approximation is not described in this method. Procedures for applying this method to an embodiment of the present invention using filtering will be hereinafter described. Note that k points are to be retrieved in the order of closeness to a center of a vicinity sphere.

In the method described in [Katayama01], clusters are traced starting in the order of closeness to a designated point, that is, a center of the vicinity starting from a root node. In the present invention, since approximation is used, an index record has to be accessed in order to calculate an accurate distance to a sphere. This makes approximation meaningless. Thus, a rough distance is found from approximate information and is regarded as a distance between a center of a substantial sphere of the sphere and a center of the vicinity. This distance is referred to as an approximate distance. The approximate distance is found by regarding a center of approximation used in case of approximating a point in II as a position of the point to calculate a distance between the position and a center of an approximate sphere.

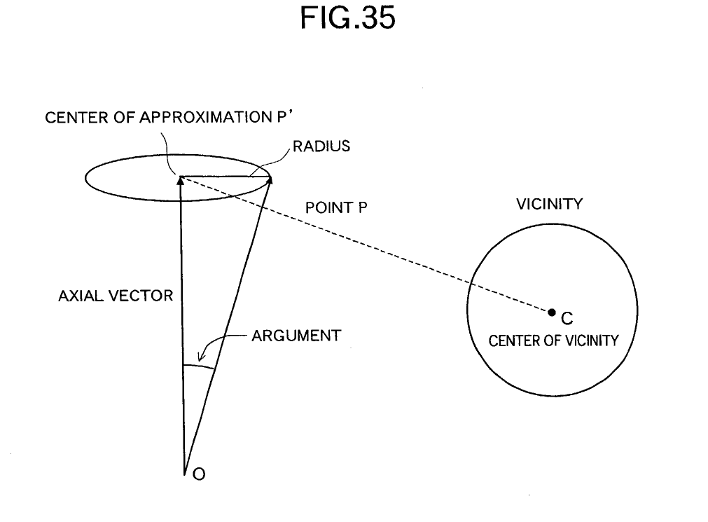

Further, this processing for tracing clusters in the order of closeness is also used in checking points. A distance between a center of approximation of a point and a center of the vicinity is also referred to as an approximate distance. P′ in FIG. 35 is the center of approximation, and C is a center of the vicinity. The approximate distance is a length of a line segment CP′. FIG. 35 represents a relationship between a point and the vicinity in the case in which the points are approximated by a ring in I described above. Although details are described in I, it will be described briefly here. It is assumed that a point P is an object point to be approximated or a center of a substantial sphere. A direction vector may be considered as a vector prepared for approximation in advance. A number is affixed to this direction vector. Therefore, the direction vector can be designated by the number. The direction vector can be easily calculated from the number.

For example, the above-described vertex vectors of a regular simplex correspond to this. A vector having a smallest angle with respect to the vector OP, that is a smallest argument is selected out of this direction vector. It is assumed that a point where a plane perpendicular to this vector and passing through the point P intersects this vector or its extension is P′. This P′ is referred to as a center of the approximation. The vector OP′ is referred to as an axial vector. A length of P′P is referred to as a radius. The point P exists on a circle (sphere in the four dimension or more) of a radius PP′ with the point P′ as a center. Therefore, a position of the point P can be limited to the above-described circle (sphere in the four multidimension) from a value of a set of three (number of direction vector, length of axial vector, and a radius). This is approximation according to a ring. There are methods of approximation other than a ring.

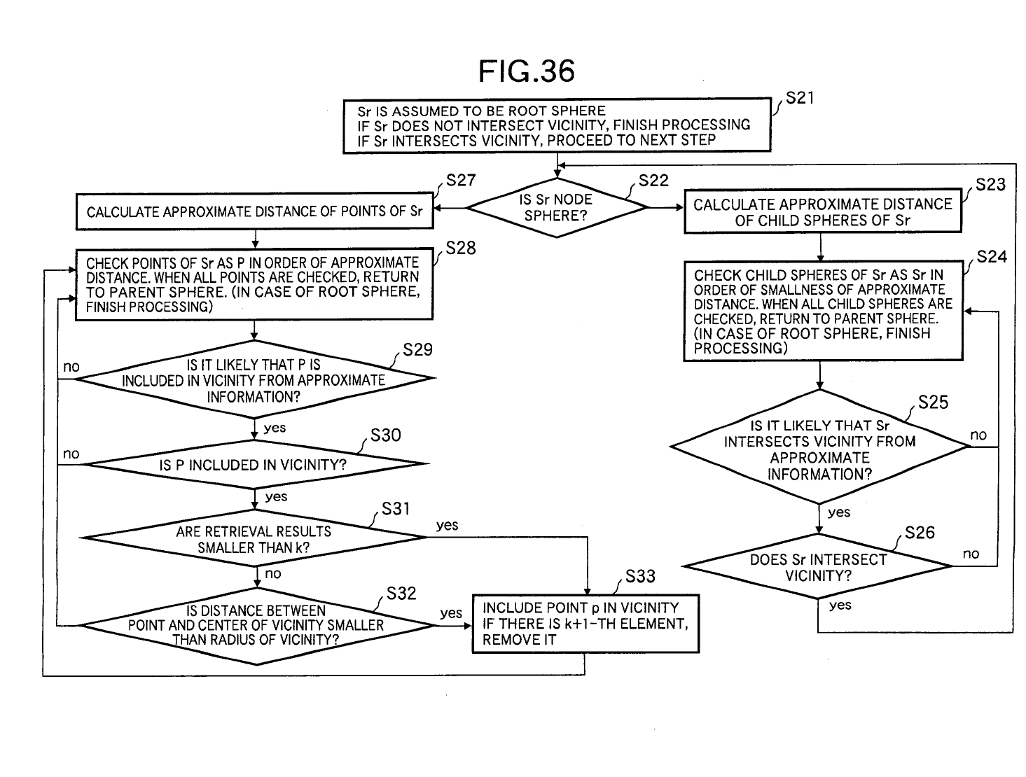

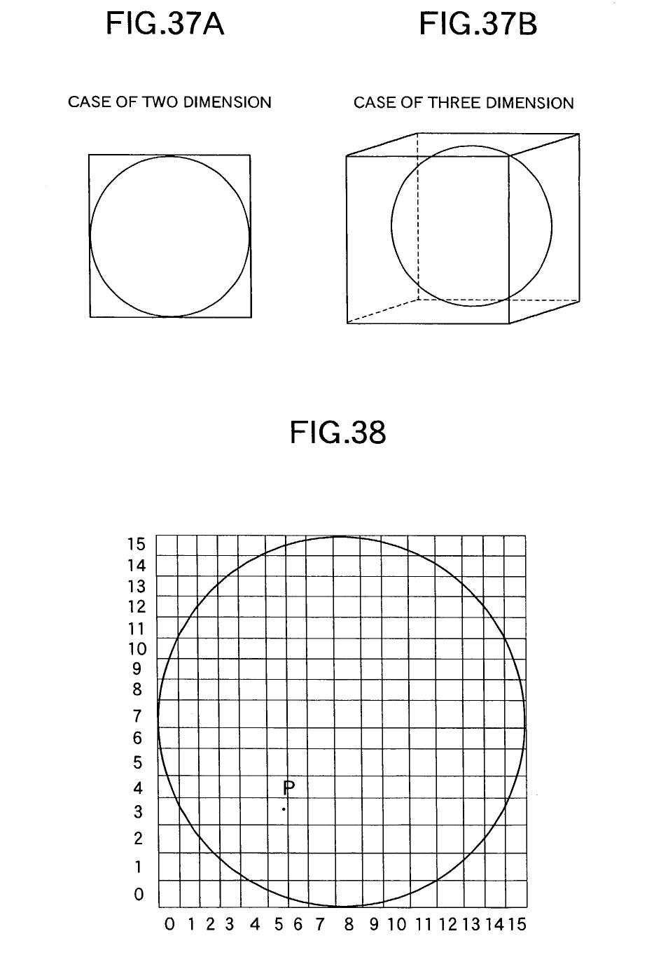

A flow of ranking processing will be hereinafter described with reference to FIG. 36. A sphere that is an object of retrieval during processing is represented as Sr. At first, Sr is a root sphere. In addition, a result of retrieval managed by the vicinity is empty at first. Further, a radius of a vicinity sphere is considered to be limitless if the number of results of retrieval is less than k.

a) If the sphere Sr is a root sphere, it is checked whether the sphere intersects the vicinity. If the sphere intersects the vicinity, processing of b) and subsequent processing are performed. If the sphere does not intersect the vicinity, the retrieval is finished (S21).

b) If the sphere Sr is a node sphere (S22, y), the following processing is applied to child spheres.

b1) An approximate distance between each child sphere and the vicinity is calculated (S23).

b2) Child spheres are retrieved in the order of shortness of an approximate distance between the spheres (S24).

b3) If it is clear by approximate information that they do not intersect, the child sphere is not retrieved (S25, n).

b4) If it is likely that they intersect (S25, y), an index record corresponding to the child sphere is accessed and whether or not they actually intersect is judged (S26).

b5) If they intersect (S26, y), processing of b) and subsequent processing are performed recursively with its child sphere as the sphere Sr that is an object of retrieval. If they do not intersect, the processing returns to step S24.

c) If the sphere Sr is a leaf sphere (S22, n), the following processing is applied to points included in Sr.

c1) An approximate distance between each point and a center of the vicinity is calculated (S27).

c2) It is judged whether or not a point record is included in the vicinity in the order of closeness of the distance calculated in c1) (S28). In this case, it is judged whether or not a point record is likely to be included in the vicinity by approximate information. Only if a point record is likely to be included (S29, y), a corresponding point record is accessed and it is judged that the point record is included.

c3) If it is found that a point is included in the vicinity (S30, y), the next processing of c4) or c5) is performed.

c4) If the number of retrieval results included in the vicinity to that point is smaller than the number k in the ranking retrieval (S31, y), the points are included in the vicinity unconditionally (S33). At the time when the number of retrieval results has reached k, an original radius is set rather than the infinite of the vicinity.

c5) If k retrieval results have already been found (S31, n), only if a distance between a point and the center of the vicinity is shorter than a radius of the vicinity (S32, y), the point is included in the vicinity. In this case, a k+1-th point appears. This point is excluded from the vicinity (S33). In order to facilitate this processing, it is assumed that, in the vicinity, points of the retrieval results are managed in the order of shortness of distance from the center of the vicinity. The radius of the vicinity is reset to a distance to a point most distant from the center of the vicinity among the retrieval results. A set of points included in the vicinity at the time when the retrieval is finished in this way is the superior ranked k retrieval results to be found. Note that it is for the purpose of decreasing the radius in the vicinity as quickly as possible and reducing the number of times of access to a point record to calculate an approximate distance between each point and the center of the vicinity and judge the distance in the order of shortness in c1) and c2).

According to the above-described embodiments of the present invention, the following effects are realized.

1) High Speed

In dividing a sphere, the sphere is divided with a regular simplex as a reference. Therefore, in general, a distance between centers of the spheres does not become shorter than a radius of the regular simplex. Therefore, a phenomenon that occurs in SR-tree or the like can be avoided in which a distance between spheres is too short and only clusters nearly overlapping with each other are created. Consequently, it is possible to perform clustering even in a high dimension and high speed in a high dimension can be realized. In addition, by using filtering, approximate information can be stored with less waste and in shorter form than a method according to conventional rectangular coordinates, an overall space can be reduced, and the number of times of input and output can be reduced. In addition, if a parent and child radius ratio is relatively close to 1, since a center of a sphere can be calculated from a growth record, the number of times of access to an index record can be reduced.

2) Efficient Point Approximation in a Sphere

Since approximate information is used only for representing points in a sphere, points in the sphere can be approximated with less approximate information. Therefore, by applying the present invention to a multidimensional index or the like using a sphere, it becomes possible to realize similarity retrieval with less costs for reading approximate information.

3) Flexibility in a High Dimension

As described in the section of the prior art, waste in representing only points in a sphere with the conventional method increases as a dimension increases. That is, this method shows more effects as a dimension becomes higher.

4) Easiness to Establish a System

Since the number of times of access to a record is controlled at the above-mentioned high speed and a system can be realized on a record basis, it can be established on an existing database system. Consequently, the system can be developed without manipulating the database system, and development costs and maintenance costs can be reduced significantly. In addition, by using a standardized language such as SQL, it is possible to establish the system on a database system product of not only a certain vendor but also a large number of companies. Although other methods can also be realized on a record basis, in general, the number of times of access to a record is large. Thus, it is likely that performance is deteriorated significantly if the methods are on a record basis. On the other hand, in the present invention, since the number of times of access to a record is controlled by filtering according to approximation, overhead does not increase so much.

As described above in detail, according to the present invention, there is an effect that a multidimensional index generation apparatus, a multidimensional index generation method, an approximate information preparation apparatus, an approximate information preparation method and a retrieval apparatus can be provided, which can divide a sphere efficiently, can realize efficiency of a storage space, can attain high speed of retrieval processing, and can establish the inside of a sphere with short approximate information to realize efficiency of a storage space and realize cost reduction, thereby performing similarity retrieval at a high speed and, at the same time, establishing apparatuses at low costs and easily.

What is claimed is:

1. A multidimensional index generation apparatus for dividing a multidimensional space into a plurality of areas and generating a multidimensional index in association with the divided areas in order to specify a predetermined point in the multidimensional space, comprising:
reference regular simplex arrangement portion adapted to arrange a regular simplex to be a reference in a certain position in said multidimensional space; and
sphere arrangement portion adapted to arrange a sphere at a vertex of said regular simplex arranged by said reference regular simplex arrangement portion and dividing said multidimensional space by said sphere.

2. The multidimensional index generation apparatus according to claim 1, further comprising connection regular simplex arrangement portion adapted to arrange a plurality of regular simplexes by connecting said regular simplex to another regular simplex with the same size as said regular simplex once or more such that surfaces of both the regular simplexes join each other,
wherein said sphere arrangement portion divides said multidimensional space by arranging a sphere on a vertex of said regular simplex arranged by said reference regular simplex arrangement portion as well as vertexes of said plurality of regular simplexes arranged by said connection regular simplex arrangement portion.

3. The multidimensional index generation apparatus according to claim 2,
wherein said reference regular simplex arrangement portion or said connection regular simplex arrangement portion arranges a further regular simplex for a sphere arranged by said sphere arrangement portion and divides said sphere in a hierarchical manner by said sphere arrangement portion arranging a further sphere at a vertex of the further regular simplex.

4. The multidimensional index generation apparatus according to claim 1,
wherein said multidimensional space is a sphere as a partial space, and said reference regular simplex arrangement portion arranges said regular simplex to be a reference such that the center of gravity of said regular simplex to be a reference coincides with a center of said sphere.

5. The multidimensional index generation apparatus according to claim 1,
wherein said multidimensional space is a sphere as a partial space, and said reference regular simplex arrangement portion arranges said regular simplex to be a reference such that the center of gravity of said regular simplex to be a reference coincides with a center of a substantial sphere by a point included in said sphere of said multidimensional space.

6. The multidimensional index generation apparatus according to claim 1, further comprising:
judging portion adapted to judge the number of vectors included in a sphere; and
vector holding portion adapted to, based on a result of judgment by said judging means, if the number of vectors included in said sphere is small, hold the vectors as they are without turning the vectors into a sphere.

7. The multidimensional index generation apparatus according to claim 1, further comprising clustering portion adapted to perform clustering by arranging identifiers specifying said object point in hierarchy based on said divided sphere.

8. A multidimensional index generation method of dividing a multidimensional space into a plurality of areas and generating a multidimensional index in association with the divided area, comprising:
a reference regular simplex arrangement step of arranging a regular simplex to be a reference in a certain position in said multidimensional space; and
a sphere arrangement step of arranging a sphere at a vertex of said regular simplex arranged by said reference regular simplex arrangement step and dividing said multidimensional space by said sphere.

9. An approximate information preparation apparatus for, in retrieving a predetermined point in a multidimensional space registered as a position in the multidimensional space, preparing approximate information obtained by approximating positional information concerning said registered point in said multidimensional space in order to reduce the number of times of access to the positional information concerning said registered point in said multidimensional space, comprising:
vector setting portion adapted to set a set of direction vectors representing a direction in said multidimensional space and, at the same time, to set a predetermined direction vector corresponding to said predetermined point using at least a part of the set of direction vectors;
axial length calculating portion adapted to find a length from an origin of said set predetermined direction vector to a closest point from the point on the predetermined direction vector as an axial length;
distance calculating portion adapted to find a length from the point to the closest point on the direction vector as a distance; and
approximate information forming portion adapted to form said approximate information based on a predetermined direction vector set by said vector setting portion, an axial length calculated by said axial length calculating portion and a distance calculated by said distance calculating portion.

10. The approximate information preparation apparatus according to claim 9,
wherein said approximate information forming portion uses a sphere formed by a direction vector set by said vector setting portion, an axial length calculated by said axial length calculating portion and a radius consisting of a distance calculated by said distance calculating portion to form approximate information on a point.

11. The approximate information preparation apparatus according to claim 9,
wherein said approximate information forming portion uses a circumference formed by a direction vector set by said vector setting portion, an axial length calculated by said axial length calculating portion, and a radius consisting of a distance calculated by said distance calculating portion to form approximate information on a point.

12. The approximate information preparation apparatus according to claim 9,
wherein said approximate information forming portion uses a circumference of a cube formed by a direction vector set by said vector setting portion, an axial length calculated by said axial length calculating portion and a radius consisting of a distance calculated by said distance calculating portion to form approximate information on a point.

13. The approximate information preparation apparatus according to claim 9,
wherein said approximate information forming portion uses a circumference of a regular quadrangle formed by a direction vector set by said vector setting portion, an axial length calculated by said axial length calculating portion and a length consisting of a distance calculated by said distance calculating portion to form approximate information on a point.

14. The approximate information preparation apparatus according to claim 9,
wherein said approximate information forming portion uses said quantized axial length and distance to form approximate information.

15. The approximate information preparation apparatus according to claim 9,
wherein said vector setting portion sets said direction vector based on each coordinate value in the case in which a predetermined point in said multidimensional space is represented by rectangular coordinates and, at the same time, sets said predetermined direction vector.

16. The approximate information preparation apparatus according to claim 9,
wherein said vector setting portion arranges a regular simplex in said multidimensional space, and uses vertex vectors as a vector from the center of gravity of said regular simplex to a vertex of all or at least a part of said regular simplex to set said direction vector and, at the same time, sets the predetermined vector.

17. The approximate information preparation apparatus according to claim 16,
wherein said vector setting portion further sets a vector formed by combining said vertex vectors to set said direction vector.

18. The approximate information preparation apparatus according to claim 16,
wherein said vertex vectors and a vector formed by using said vertex vectors are normalized.

19. The approximate information preparation apparatus according to claim 16,
wherein said vector setting portion comprises:
a portion for arranging a regular simplex in said multidimensional space, selecting k(k<=n) vectors v(i(1)), v(i(2)), . . . , v(i(k)) in order from one having a smallest argument with an object vector out of vertex vectors as vectors from the center of gravity of said regular simplex to the vertex of the regular simplex, and finding vectors g(1), g(2), . . . , g(k) as
g(1)=v(i(1))
g(2)=(v(i(1))+v(i(2))/2
. . .
g(k)=(v(i(1))+v(i(2))+ . . . +v(i(k)))/k;
a portion for finding a vector g=n((g(1)+g(2)+ . . . +g(k))/k) that is found by normalizing vectors to centers of gravity of g(1), g(2), . . . , g(k) to set them as direction vectors; and
a portion for using numbers i(1), i(2), . . . , i(k) of vertex vectors as said predetermined vector to set said predetermined vector.

20. The approximate information preparation apparatus according to claim 16,
wherein said vector setting portion comprises:
a portion for arranging a regular simplex in said multidimensional space, selecting k(k<=n) vectors v(i(1)), v(i(2)), . . . , v(i(k)) in order from one having a smallest argument with an object vector out of vertex vectors as vectors from the center of gravity of the regular simplex to the vertex of the regular simplex, and finding vectors g(1), g(2), . . . , g(k) as
g(1)=n(v(i(1)))
g(2)=n((v(i(1))+v(i(2))/2)
. . .
g(k)=n((v(i(1))+v(i(2))+ . . . +v(i(k)))/k); and
a portion for, based on g(1), g(2), . . . , g(k), finding a vector g(i) having a smallest argument with an object vector among them, finding a vector m(j) from the origin O to a midpoint of g(j) (j≠i) and g(i) as
m(j)=(g(i)+g(j))/2,
finding a vector group g(1), g(2), . . . , g(k) found by normalizing this m(j), and repeating this processing t times and, thereafter, setting a direction vector by finding the center of gravity g of g(1), g(2), . . . , g(k) and normalizing the center of gravity g, and setting said predetermined vector by a set of (j1, j2, . . . , jt).

21. The approximate information preparation apparatus according to claim 9, wherein said vector setting portion uses an angle to set said direction vector.

22. The approximate information preparation apparatus according to claim 21,
wherein, if a point on a spherical surface in an n-dimensional space is represented by
(θ, φ(3), (4), . . . , φ(n))
0<=θ<=2π
−π/2<=φ(i)<=π/2 (3<=i<=n)
with φ(i) as an angle in an i-dimension, said vector setting means sets a direction vector and, at the same time, sets said predetermined vector by quantizing angles θ and φ(i).

23. The approximate information preparation apparatus according to claim 22,
wherein said vector setting portion, assuming that
A=π/(2\hat{ }a)
B=π/(2\hat{ }b),
further associates j satisfying jA<=θ<(j+1)A (0<=j<2\hat{ }a) with θ and k(i) satisfying k(i)A<=φ(i)+π/2<(k(i)+1)A (0<=k(i)<2\hat{ }b) with φ(i) to set a direction vector and, at the same time, sets said predetermined vector by c=(j, k(3), k(4), . . . , k(n)).

24. The approximate information preparation apparatus according to claim 9,
wherein said vector setting portion sets a direction vector by recursively dividing a dimension of a vector obtained by normalizing an object vector as a vector representing said predetermined point, constituting an identifier using a ratio of length, and assigning bits such that a surface area of a divided sphere and the number according to a bit assigned to a divided vector are proportional to each other.

25. An approximate information preparation method of, in retrieving a predetermined point in a multidimensional space registered as a position in said multidimensional space, preparing approximate information obtained by approximating positional information concerning said registered point in said multidimensional space in order to reduce the number of times of access to said positional information concerning said registered point in said multidimensional space, comprising:
a vector setting step of setting a set of direction vectors representing a direction in said multidimensional space and, at the same time, setting a predetermined direction vector corresponding to said predetermined point using at least a part of said set of direction vectors, a step of finding a length from an origin of said set predetermined direction vector to a closest point from the point on said predetermined direction vector as an axial length and finding a length from the point to the closest point on said direction vector as a distance; and
an approximate information forming step of forming said approximate information based on a predetermined direction vector set by said vector setting step, a calculated axial length and a calculated distance calculated by said step of finding an axial length and a distance.

26. A retrieval apparatus that retrieves an item identical with or similar to a designated one from a memory unit storing a plurality of objects, comprising:
a multidimensional index generation unit for dividing a multidimensional space into a plurality of areas to generate a multidimensional index in association with the divided areas in order to specify a predetermined object in said multidimensional space, said multidimensional index generation unit comprising reference regular simplex arranging portion adapted to arrange a regular simplex to be a reference in a certain position in said multidimensional space and sphere arranging portion adapted to arrange a sphere at a vertex of said regular simplex arranged by said reference regular simplex arranging portion and dividing said multidimensional space by the sphere; and
a retrieval unit for using a multidimensional index generated by said multidimensional index generation unit to retrieve said object.

27. The retrieval apparatus according to claim 26,
wherein said multidimensional index generation unit comprises an approximate information preparation unit for, in retrieving a predetermined point in a multidimensional space that is registered as a position in said multidimensional space, preparing approximate information that is obtained by approximating positional information concerning said registered point in said multidimensional space in order to reduce the number of times of access to positional information concerning said registered point in said multidimensional space.

28. The retrieval apparatus according to claim 26,
wherein said approximate information preparation unit comprises:
vector setting portion adapted to set a set of direction vectors representing a direction in said multidimensional space and, at the same time, setting a predetermined direction vector corresponding to said predetermined point using at least a part of said set of direction vectors;
axial length calculating portion adapted to find a length from an origin of said set predetermined direction vector to a closest point from the point on said predetermined direction vector as an axial length;
distance calculating portion adapted to find a length from the point to the closest point on said direction vector as a distance; and
approximate information forming portion adapted to form said approximate information based on a predetermined direction vector set by said vector setting portion, an axial length calculated by said axial length calculating portion and a distance calculated by said distance calculating portion.

29. A multidimensional index generation program for dividing a multidimensional space into a plurality of areas and generating a multidimensional index in association with the divided areas, which is stored in a computer readable storage medium, said multidimensional index generation program causing a computer to execute:
a reference regular simplex arrangement step of arranging a regular simplex to be a reference in a certain position in said multidimensional space; and
a sphere arrangement step of arranging a sphere at a vertex of said regular simplex arranged by said reference regular simplex arrangement step and dividing said multidimensional space by said sphere.

30. An approximate information preparation program for, in retrieving a predetermined point in a multidimensional space registered as a position in the multidimensional space, preparing approximate information obtained by approximating positional information concerning said registered point in said multidimensional space in order to reduce the number of times of access to said positional information concerning said registered point in said multidimensional space, which is stored in a computer readable storage medium, said approximate information preparation program causing a computer to execute:
a vector setting step of setting a set of direction vectors representing a direction in said multidimensional space and, at the same time, setting a predetermined direction vector corresponding to said predetermined point using at least a part of said set of direction vectors;
a step of finding a length from an origin of said set predetermined direction vector to a closest point from the point on said predetermined direction vector as an axial length and finding a length from the point to the closest point on said direction vector as a distance; and
an approximate information forming step of forming the approximate information based on a predetermined direction vector set by said vector setting step, a calculated axial length and a calculated distance calculated by said step of finding an axial length and a distance.
